(19) United States
(12) Patent Application Publication
(10) Pub. No.: US 2005/0080935 A1
(43) Pub. Date: Apr. 14, 2005

(54) Device-side controller, host-side controller, communication controller, USB system, and packet communications method

(76) Inventors: Fumihiro Fukae, Sakurai-shi (JP); Hitoshi Naoe, Kitakatsuragi-gun (JP); Koji Sakai, Osaka (JP); Shohei Osawa, Kitakatsuragi-gun (JP)

Correspondence Address: BIRCH STEWART KOLASCH & BIRCH, PO BOX 747, FALLS CHURCH, VA, 22040-0747, US

(21) Appl. No.: 10/951,678

(22) Filed: Sep. 29, 2004

(30) Foreign Application Priority Data
Sep. 29, 2003 (JP) 2003-337952
Jul. 23, 2004 (JP) 2004-216495

(51) Int. Cl. G06F 3/00

(52) U.S. Cl. 710/1

(57) ABSTRACT

A host-side control section of a host-side controller, when having received a SOF packet transmitted from a host to a device, avoids transmission of the received SOF packet to a device side. A device-side control section of a device-side controller transmits a SOF packet to the device at a predetermined interval after connection between the host and the device has been established. This eliminates the need for SOF packet transmission between the controllers. Thus, a communication bandwidth between the controllers of low communication speeds can be used only for packets other than the SOF packet. This increases communication efficiency of these other packets.

This Nonprovisional application claims priority under 35 U.S.C. § 119(a) on Patent Application No. 2003/337952 filed in Japan on Sep. 29, 2003, and Patent Application No. 2004/216495 filed in Japan on Jul. 23, 2004, the entire contents of all of which are hereby incorporated by reference.

### FIELD OF THE INVENTION

The present invention relates to a USB system that is a communications system for realizing USB communications (data communications according to the USB standard) between a host computer (host) and its peripheral (device).

### BACKGROUND OF THE INVENTION

A universal serial bus (hereinafter referred to as USB) is an interface developed for high expansion flexibility involving a peripheral (device) which is connected to a host such as a personal computer. The USB is serial interface standards for communications between the host and various USB-support devices using a common bus line.

In theory, the USB allows for connections between one host (USB host) and up to 127 devices on one bus in one system. These connections physically have a hierarchical network structure. Logically, it can be said that these connections are based on a one-to-one connection between a host (client software) and a device (USB function). To maintain such connections, each device communicates with a host by time-sharing. Further, the host performs scheduling for time-sharing.

In USB1.x, two modes of different data transfer speeds, i.e. low speed (LS) mode of 1.5 Mbps and full speed (FS) mode of 12 Mbps are specified.

However, in recent years, the USB has been increasingly applied to a device (application) which requires a high-speed data transfer, such as a hard disk and a DVD (Digital Versatile Disc). Therefore, the transfer speeds as described above are not sufficient for that device.

In view of this, a new standard, USB 2.0, has been established. In the USB 2.0, a high speed (HS) mode which allows data transfer of 480 Mbps is added.

Here, a structure of data communications (data transfer) using the USB will be simply described below. Data transfer of the USB is performed between buffers of the host and the device.

A device-side buffer is a FIFO (First In First Out) buffer called endpoint. Each device can have up to 16 endpoints. Each of the endpoints is given a number for identification.

At the time of data transfer, the host makes access to an endpoint that the host wants, using an address and endpoint number of a device.

Note that, an endpoint 0 (endpoint numbered 0) is set in a state immediately after the device is connected to the USB (a state before configuration), and the endpoint 0 is used for communications with the host for control transfer (communications for initialization, or the like).

A host-to-device data communications are performed using a communication frame called frame. This frame is repeatedly transmitted between the host and the device at predetermined intervals (in LS and FS modes, intervals of 1 ms, and in HS mode, intervals of 125 μs). All data are contained in this frame for transmission.

Further, this frame is constructed by a plurality of transactions, and each of the transactions is made up of a plurality of packets.

The packet is the smallest communication unit making up the transaction and is a basic unit of data that is practically communicated. There are several kinds of packets, depending on their roles, including token packet, data packet, and handshake packet. An entity including a plurality of packets to be a significant unit for data transfer is called transaction.

That is, data communications under the USB are performed for each of the transactions in the frame. For one transaction, a plurality of packets are transferred between the host and the device.

The token packet includes the address and endpoint number of each device, which allows the host to designate a destination of data communications.

FIG. 11 is an explanatory diagram illustrating types of a USB packet. As illustrated in FIG. 11, there are the following types of packets: token packet, data packet, handshake packet, and special packet.

The token packet includes IN packet, OUT packet, SETUP packet, and SOF packet. The packets are used for respective purposes illustrated in FIG. 11. Examples of the data packet include DATA0 packet and DATA1 packet. The handshake packet includes ACK packet, NAK packet, STALL packet, and NYET packet. Examples of the special packet include PING packet.

FIG. 12 is an explanatory diagram illustrating a USB packet format. A PID illustrated in FIG. 12 is a packet identifier and contains 8 bits. In addition, CRC5 and CRC16 are added to the token packet and the data packet, respectively. These CRCs are used to judge whether or not any errors are in a received packet.

Note that, the SOF (Start of Frame) packet, one of the token packets, is a packet representing the start of a frame which the host issues. This SOF packet has a function of indicating that a bus between the host and the device is not reset.

A USB cable includes four lines: two lines for a D+ signal line and a D− signal line; a line for a power source; and a line for the ground. Further, in the USB 2.0, to obtain a bus reset state in the HS mode, the host causes the D+ signal line and the D− signal line to be in low levels (in SE0 state) for 10 ms or longer, as a bus reset signal.

When detecting this SE0 state for 3 ms or longer, the device recognizes the bus reset state. Note that, the SE0 state is the same as an idle state. Thus, if the device receives no packets for 3 ms or longer, the device recognizes the bus reset state and then makes disconnection with the host.

Such a disconnection often makes it impossible to return the bus (re-recognize the device) even if a physical connection to the device is made (even if a connector of the cable is inserted and extracted). Therefore, for realization of bus return, the host must be rebooted.

In view of this, to avoid such a circumstance, the USB system is arranged such that the SOF packet is placed at the head of the frame, and the SOF packet is transmitted periodically and in precedence to other packets, from the host to the device. That is, the host constantly transmits, to the device (device that is not subjected to bus reset) connected to the USB system (cable), the SOF packet at intervals of 1 ms in the LS and FS modes and at intervals of 125 μs in the HS mode.

Note that, in the USB standard, it is set such that such a SOF packet is transmitted in preference to other packets. Upon receipt of such a SOF packet, a device sends back no response to the host. Further, this SOF packet is used for synchronization between the host and the device at the time of isochronous transfer.

Next, the following will describe each of the transactions in the USB communications. In the USB 2.0 standards, the IN transaction is used for the host to read out data from the device. The following will describe the IN transaction with reference to FIG. 13.

First, at Timing T301 (hereinafter simply referred to as “T301”), the host transmits the IN packet to the device to notify the device of start of the IN transaction. The device having received the IN packet, if having no data to be transmitted to the host, transmits a NAK packet to the host at T302. The NAK packet indicates no data to be transmitted to the host. The host having received the NAK packet recognizes that the device has no data to be transmitted to the host. Then, at a next transmission timing (T303), the host transmits the IN packet to the device again.

The device having received the IN packet, if having data to be transmitted to the host, transmits a DATA packet to the host at T304. The host, when having received the DATA packet without errors within a predetermined period of time, transmits an ACK packet to the device at T305. The ACK packet indicates that data have been received normally. The device can recognize that data have been normally transmitted to the host, by receiving the ACK packet within a predetermined period of time.

Note that, the DATA packet transmitted to the host at T304 has a code of CRC16 added thereto. From CRC16, the host (data receiving end) can judge whether or not any errors are in the received data.

Note that, if it is judged from CRC16 that errors are in the received data, the host sends back no packet. Accordingly, in this case, the device cannot receive the ACK packet from the host within a predetermined period of time. Therefore, the device recognizes that the device has failed to normally transmit data to the host and recognizes that the IN transaction has ended in failure.

The IN transaction as described above allows the host to obtain (read out) data from the device.

Moreover, in the USB 2.0 standards, in the case when the host writes data into the device, the OUT transaction is used. The following will describe the OUT transaction with reference to FIG. 14.

First, at T401, the host transmits an OUT packet to the device to notify the device of start of the OUT transaction. Thereafter, the host transmits a DATA packet to the device at T402.

The device performs CRC check of the received OUT packet and DATA packet to judge whether or not any errors are in the received packets. If no errors are in the received packets, the device sends back an ACK packet to the host when the device is ready for processing the DATA packet. On the other hand, when the device is not ready for processing the DATA packet, the device sends back a NAK packet to the host. When errors are in the received packets, the device sends back no response to the host.

In FIG. 14, at T403, the device sends back the NAK packet to the host so as to notify that no errors are in the received packet but the device cannot process data. The host having received this NAK packet recognizes that the device is not ready for processing the received packet. Then, to know a status of the device, the host transmits a PING packet to the device at T404.

The device having received the PING packet transmits the ACK packet to the host when the device is ready for processing data, or transmits the NAK packet to the host when the device is not ready for processing data.

In FIG. 14, at T405, the device transmits the ACK packet to the host so as to notify that the device is ready for processing data. The host recognizes that the device is ready for processing data since the ACK packet has been sent back in response to the PING packet.

Note that, when having received the NAK packet in response to the PING packet, the host recognizes that the device is not ready for processing data, and transmits the PING packet again. Here, the host repeatedly transmits the PING packet until the device is ready for processing data (until the host receives the ACK packet).

In FIG. 14, the host having received the ACK packet in response to the PING packet again transmits to the device the OUT packet and the DATA packet at T406 and T407, respectively.

The device having received the OUT packet and the DATA packet is now ready for processing data. Therefore, after CRC check of the received packets, the device transmits the ACK packet if no errors are in the received packets. By receiving the ACK packet, the host recognizes that the OUT packet and the DATA packet have been transmitted without errors and processed by the device. Then, the host ends the OUT transaction. Such OUT transaction allows the host to write data into the device.

Next, the following will describe the SETUP transaction. The SETUP transaction, in the USB 2.0 standards, is performed to establish a system connection between the host and the device (to complete configuration) when the device is connected to the host. Note that, in this transaction, the host performs data transfer with respect to the endpoint 0 of the device. The following will describe the SETUP transaction with reference to FIG. 15.

In the SETUP transaction, at T501, the host transmits SETUP packet to the device so as to notify the start of the SETUP transaction. Thereafter, at T502, the host transmits DATA packet. The device performs CRC check of the received SETUP packet and the DATA packet.

If it is judged that no errors are in the received packets, the device transmits ACK packet to the host at T503. On the other hand, if it is judged that errors are in the received SETUP packet and DATA packet, the device sends back no response to the host.

By receiving the ACK packet, the host recognizes that the SETUP packet and the DATA packet have been normally transmitted to the device. Then, the host ends the SETUP transaction.

Note that, when the host cannot receive the ACK packet within a predetermined period of time after transmission of the DATA packet, the host recognizes that the host has failed to normally transmit the SETUP packet or the DATA packet to the device, i.e. the host recognizes that the SETUP transaction has ended in failure.

In this manner, it is possible to perform the SETUP transaction between the host and the device.

By the way, in recent years, mobile devices such as digital camera and PDA (personal digital assistant) have compliant.

In many cases, a cradle scheme is used for connections between these mobile devices and the host. That is, a USB connector of a cradle connected to the host is connected to a USB connector of a mobile device, which enables USB transmissions.

These USB connectors have physical contacts. Therefore, insertion and extraction of the connectors cause deterioration of the connectors. This might make it impossible to perform data transfer of high quality.

As the technology of transmissions free from the aforementioned physical contacts, there is the technology of optically-based free-space transmissions between the host and the mobile devices. Such technology is disclosed in Japanese Laid-Open Patent Application No. 2000-284872 (Tokukai 2000-284872; published on Oct. 13, 2000).

However, for a perfect compliance with a high speed mode of the USB 2.0, it is necessary to perform free-space optical transmissions of data while maintaining a transfer speed of 480 Mbps. This requires the host and the device provided with respective optical communication sections (optical system and transmission/reception section) having a high CDR (Clock Data Recovery) capability, thus resulting in increase in cost.

To suppress increase in cost, it is considered to perform data transfer based on USB 2.0, with a lowered transfer speed in optical communications.

FIG. 16 is a timing chart illustrating a manner in which SOF packets are transmitted in the situation where the host and an optical communication section of the host (host optical communication section) communicate each other at a transfer speed of 480 Mbps, the host optical communication section and an optical communication section of the device (device optical communication section) communicate each other at a transfer speed of 100 Mbps, and the device optical communication section and the device communicate each other at 480 Mbps. Note that, this transmission of the SOF packet is made to notify to the device that the bus is not reset.

As illustrated in FIG. 16, at T601, the SOF packet having been transmitted from the host is converted into optical signals in the host optical communication section and is then transmitted to a device optical communication section. The device optical communication section, when receiving the SOF packet, repeats the SOF packet to the device. The host transmits a new SOF packet at T602 125 μs later, without waiting a response from the device.

However, in such an arrangement, a transfer speed in the communications between the optical communication sections is low, so that a time required for transmission of the SOF packet is longer than an inherent (native) time for transmission of the SOF packet in the USB 2.0. Further, regardless of a communication speed, the SOF packet is transmitted in preference to other packets at intervals of 125 μs. This increases a proportion of SOF packet transmission in an optical communication bandwidth, so that a proportion of other packets transmission decreases, resulting in a significant decrease in communication efficiency between the host and the device.

### SUMMARY OF THE INVENTION

The present invention has been attained in view of the aforementioned conventional problem. An object of the present invention is to provide a USB system capable of suppressing decrease in communication efficiency even with a communication channel of lower speed (e.g. an optical communication channel of 100 Mbps) than an inherent communication speed in the USB standard.

In order to achieve the above object, a device-side controller of the present invention (the present device-side controller) is a device-side controller, provided to a device of a USB system, which relays communications between the device and a host, the device-side controller comprising: a device-side control section which, after connection between the host and the device is established, transmits a SOF packet to the device.

A host-side controller of the present invention (the present host-side controller) is a host-side controller, provided to a host of a USB system including the host, a device, and the present device-side controller, the host-side controller comprising: a host-side control section which, when having received a SOF packet transmitted from the host to the device, avoids transmission of the received SOF packet to a device side.

A device-side controller of the present invention (the present device-side controller) is a device-side controller, provided to a device of a USB system, which relays communications between the device and a host, the device-side controller comprising: a device-side control section which, after connection between the host and the device is established, transmits a SOF packet to the device at a predetermined interval.

The present device-side controller is applied to a USB system. Here, the USB system is a communications system for realizing USB communications (data communications according to the USB standard) between a host computer (host) and its peripheral (device; USB function).

The present device-side controller is provided to the device of the USB system and relays communications between the host and the device. That is, the present device-side controller has a function of receiving a packet transmitted from the device and transmitting it to the host, and a function of receiving a packet transmitted to the device and transmitting it to the device. Here, the packet is a basic unit of data communicated in the USB system.

Further, the USB system is defined so that the SOF packet, one of packets, is transmitted in preference to other packets, from the host to the device. The present device-side controller includes a device-side control section which generates this SOF packet on its own initiative and transmits it to the device.

With this arrangement, the use of the present device-side controller eliminates the need for transmission and reception of the SOF packet between the host and the present device-side controller (i.e. the use of the present device-side controller eliminates the need for transmission of the SOF packet from the host side to the device.). With this arrangement, a communication channel between the host and the present device-side controller can be used only for packets other than the SOF packet. This allows increase in communication efficiency of these other packets.

A USB system of the present invention (the present system) is a USB system including the present device-side controller, in addition to the host and the device. Establishment of such a system enables increase in communication efficiency of packets. Further, the present system preferably includes the present host-side controller as described below. The present host-side controller is provided to the host and relays communications between the host and the device. That is, the host-side controller receives a packet transmitted from the host and transmits it to the device as well as receives a packet transmitted to the host and transmits it to the host.

Thus, if the present system includes the host, the present host-side controller, the present device-side controller, and the device, a communication channel of the present system is provided in this order. That is, the communication channel is set such that the present host-side controller and the present device-side controller relay communications between the host and the device.

A packet communications method of the present invention (the present communications method) is a packet communications method of communicating packets between a host and a device in a USB system, the method comprising: a transmission avoidance step of, a host-side control section in a host-side controller provided to the host, avoiding transmitting, to a device side, a SOF packet having been transmitted from the host; and a transmission step of, a device-side control section in a device-side controller provided to the device, transmitting a SOF packet to the device.

The present communications method is a communications method used in the above present system. Therefore, adoption of the present communications method facilitates increase in communication efficiency between controllers.

Further, a first communication controller of the present invention (the present first communication controller) is a communication controller which relays communications between a host and a device and includes functions as a host-side controller and a device-side controller, the communication controller comprising: a communication control section which, while the communication controller functions as the device-side controller, transmits a SOF packet to the device after connection between the host and the device has been established.

Still further, a second communication controller of the present invention (the present second communication controller) is a communication controller which relays communications between a host and a device and includes functions as a host-side controller and a device-side controller, the communication controller comprising: a communication control section which, when having received a SOF packet transmitted from the host to the device while the communication controller functions as the host-side controller, avoids transmission of the received SOF packet to a device side.

Thus, the present communication controller has a function as the host-side controller and a function as the device-side controller. With this arrangement, in the USB system, one communication controller can be used as either the host-side controller or the device-side controller.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram illustrating a configuration of a USB system according to one embodiment of the present invention.

FIG. 2 is a flowchart (state transition diagram) illustrating operation of a host SM in a host-side controller, in a process for resetting a bus of a device in the USB system illustrated in FIG. 1.

FIG. 3 is a timing chart illustrating an example of speed negotiation in the USB system illustrated in FIG. 1.

FIG. 4 is an explanatory diagram illustrating the operation of a SNSM in a host-side controller in the speed negotiation.

FIG. 5 is an explanatory diagram illustrating the operation of a SNSM in a device-side controller in the speed negotiation.

FIG. 6 is a timing chart illustrating an example of a case where a SOF packet cannot be transmitted in IN transaction.

FIG. 7 is an explanatory diagram illustrating the size of a DATA packet.

FIG. 8 is a flowchart illustrating a flow of the operation of a device SM in the present system illustrated in FIG. 1, in the IN transaction.

FIG. 9 is a timing chart illustrating an example of a case where a SOF packet cannot be transmitted in OUT transaction.

FIG. 10 is a flowchart illustrating a flow of the operation of a device SM in the present system illustrated in FIG. 1, in the OUT transaction.

FIG. 11 is an explanatory diagram illustrating types of a USB packet.

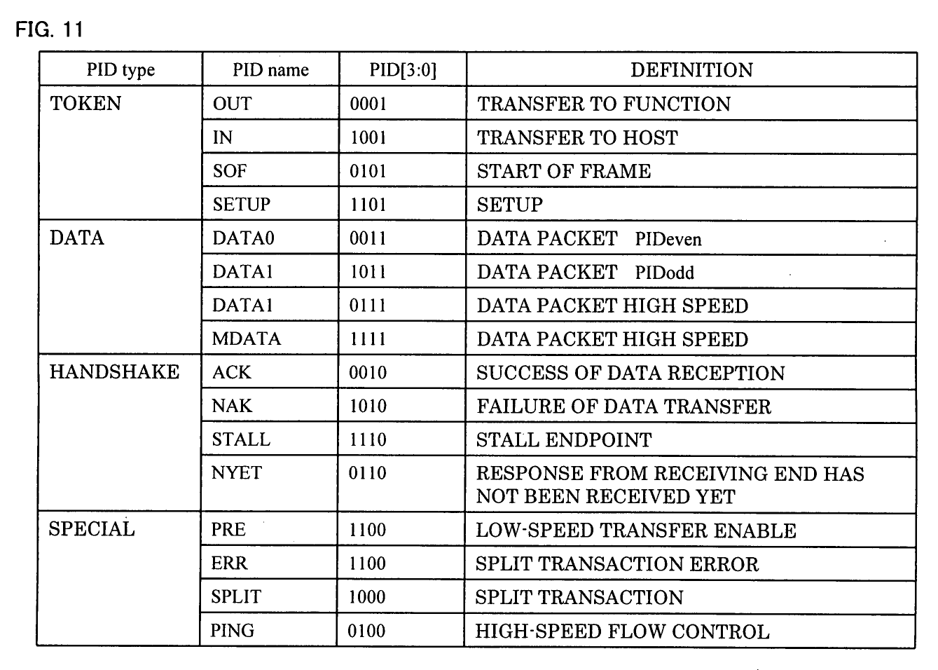

FIG. 12 is an explanatory diagram illustrating a USB packet format.

FIG. 13 is a timing chart illustrating an example of IN transaction.

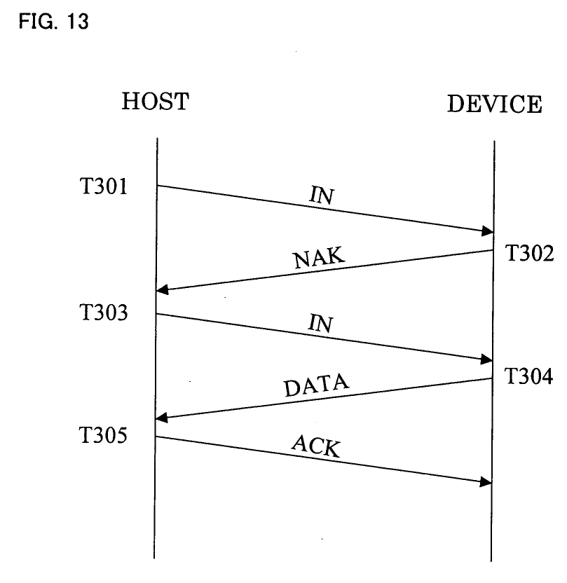

FIG. 14 is a timing chart illustrating an example of OUT transaction.

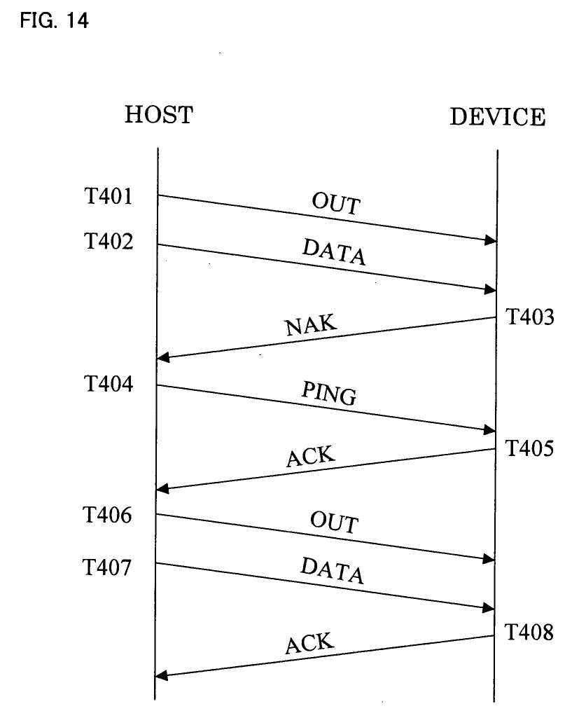

FIG. 15 is a timing chart illustrating an example of SETUP transaction.

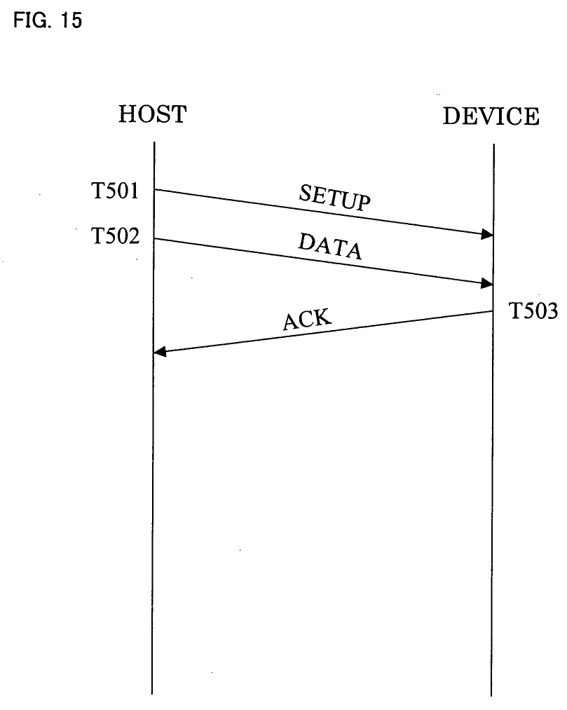

FIG. 16 is a timing chart illustrating a manner in which SOF packets are transmitted in the conventional USB system.

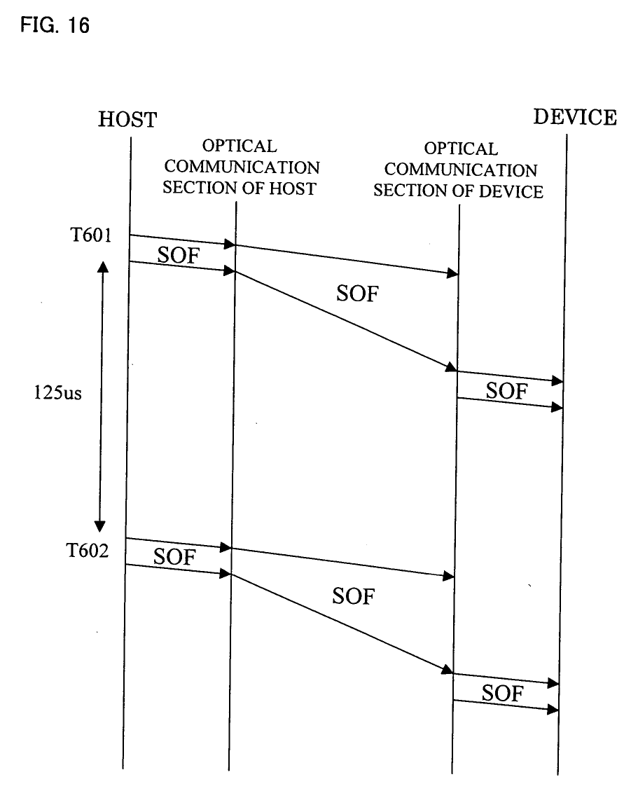

FIG. 17 is a block diagram illustrating a configuration of a USB system using a communications controller according to one embodiment of the present invention.

### DESCRIPTION OF THE EMBODIMENTS

The following will describe one embodiment of the present invention. A USB system according to the present embodiment is a communication system for realizing a USB communications (data communications using USB 2.0) between a host computer (host) and its peripheral (device).

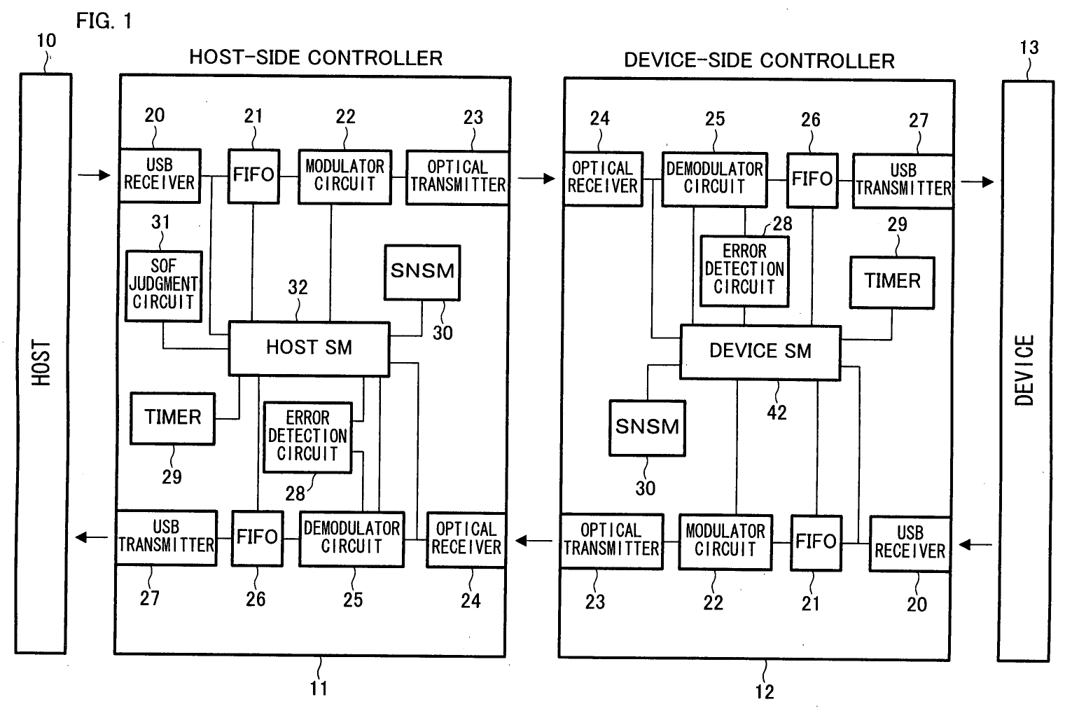

FIG. 1 is a block diagram illustrating a configuration of the present system. As illustrated in FIG. 1, the present system includes a host 10, a host-side controller 11, a device-side controller 12, and a device 13.

The host (USB host) 10 is a personal computer which is a master in the present system, and controls all of the USB communications. Further, the device (USB function, USB device) 13 is a slave (node) which performs communications with the host 10, and functions as a peripheral of the host, such as a printer and a DVD driver.

The host-side controller 11, which is connected to the host 10 via a USB cable, relays USB communications between the host 10 and an external entity (device 13). In other words, as well as receiving a packet transmitted from the host 10 and then transmitting it to the external entity, the host-side controller 11 receives a packet transmitted to the host 10 and then transmits it to the host 10.

The device-side controller 12, which is connected to the device 13 via a USB cable, relays USB communications between the device 13 and the host 10. In other words, as well as receiving a packet transmitted from the device 13 and then transmitting it to the host 10, the device-side controller 12 receives a packet transmitted to the device 13 and then transmits it to the device 13.

In addition, in the present system, the controllers 11 and 12 are connected to each other through USB-compliant optical wireless communications. In other words, in the present system, USB communications between the host 10 and the device 13 are made through optical wireless communications by the controllers 11 and 12. Note that, a data transfer speed in the optical wireless communications between the controllers 11 and 12 is 100 Mbps and is lower than a data transfer speed (480 Mbps) in the high speed (HS) mode of USB 2.0.

Here, the following will describe a configuration of the controllers 11 and 12, which is a characteristic to the present system. As illustrated in FIG. 1, the host-side controller 11 includes a USB receiver 20, a transmission FIFO 21, a modulator circuit 22, an optical transmitter 23, an optical receiver 24, a demodulator circuit 25, a reception FIFO 26, a USB transmitter 27, an error detection circuit 28, a timer 29, a speed negotiation state machine (SNSM) 30, a SOF judgment circuit 31, and a host-side state machine (host SM) 32.

Meanwhile, the device-side controller 12 includes the members 20 through 30 of the host-side controller 11 and a device-side state machine (device SM) 42.

The USB receiver 20, which is connected to the host 10 or the device 13 via a USB cable, receives a USB signal (signal including a packet) transmitted from the host 10 or the device 13.

The transmission FIFO 21 temporarily stores a packet which the USB receiver 20 receives. More specifically, the transmission FIFO 21 is used for adjustment of a timing for transfer (repeat) of a packet through optical communications since, as mentioned above, the communication speed between the controllers 11 and 12 (100 Mbps) is lower than the maximum communication speed in communications with the USB cable (in the HS mode, 480 Mbps).

The modulator circuit 22 performs modulation (optical modulation) of a packet to transmit the packet to an external entity through optical communications. As a modulation scheme of the modulator circuit 22, 8B10B can be adopted, for example. The optical transmitter 23 transmits a packet modulated by the modulator circuit 22 to the external entity and is realized by a light emitting diode device or a laser device.

The optical receiver 24 receives the optical modulated packet from the external entity and is realized by a photodiode, for example. Note that, the optical receiver 24, when having received some kind of optical signal, transmits a signal-detect signal to the host SM 32 (device SM 42) or the SNSM 30. This signal-detect signal is a signal for judging whether or not there is any received signal. The demodulator circuit 25 demodulates a packet received by the optical receiver 24 so that the packet can be transmitted via the USB cable. As a demodulation scheme of the demodulator circuit 25, 8B10B can be adopted, for example.

The reception FIFO 26 temporarily stores a demodulated packet. Further, the reception FIFO 26, as with the transmission FIFO 21, is used for adjustment of a timing for transfer (repeat) of a packet by means of the USB cable, so as to compensate for a difference in communication speed between data transmission with the USB cable and data reception through optical communications.

The error detection circuit 28 is a circuit which judges whether or not any error is in the packet demodulated by the demodulator circuit 25. The USB transmitter 27, which is connected to the host 10 or the device 13 via the USB cable, transmits a packet (USB signal including a packet) stored in the reception FIFO 26 to the host 10 or the device 13. The timer 29 is a timer (time measurement device) used for the host S M 32 or the device SM 42. The SNSM (speed setting section) 30 is a control section for performing speed negotiation described later.

In the host-side controller 11, a SOF judgment circuit (host-side control section) 31 is a circuit which judges whether or not a packet received by the USB receiver 20 is a SOF packet. The host S M (host-side control section) 32 is a center of the host-side controller 11, which controls all operations of the host-side controller 11.

Similarly, the device SM (device-side control section) 42 in the device-side controller 12 functions as a center which controls all operations of the device-side controller 12.

Here, data communication operation in the present system will be described. Firstly, operation of the device 13 at the time of connection will be described. When the device 13 is connected to the present system via the controllers 11 and 12, the host 10 first detects whether or not the device 13's power is turned on. This is achieved by checking a VBUS signal in signals running on four signal lines (D+, D−, power supply (VBUS), and GND) of the USB cable.

Next, the host 10 detects a speed of the device 13 (what modes the device 13 includes provisions for). Then, if the device 13 includes provisions for the full speed (FS) mode or the high speed (HS) mode, the host 10 pulls up a D+ signal. On the other hand, if the device 13 includes provisions only for the low speed (LS) mode, the host 10 pulls up a D− signal. Note that, the following descriptions assume that the device 13 includes provisions for the HS mode.

Next, the host 10 makes the D+ signal line and the D− signal line to be in a low level (SE0 state) for 10 ms or longer, so as to reset a bus of the device 13. Thereafter, the device 13 transmits a signal unique to the HS mode (signal called CHIRP) to the host 10 via the controllers 11 and 12. The host 10 also transmits a signal unique to the HS mode to the device 13 via the controllers 11 and 12.

This allows the host SM 32 and the device SM 42 to check that communications between the host 10 and the device 13 are performed in the HS mode. Thereafter, the host SM 32 and the device SM 42 control the respective SNSMs 30 to cause them to perform speed negotiation between the controllers 11 and 12 (which will be described later). This establishes (completes) a connection (bus) between the host 10 and the device 13.

After the device 13 has been connected to the present system, data transfer between the host 10 and the device 13 is carried out via the controllers 11 and 12. When the USB signal (signal including a packet) is transmitted from the host 10 to the device 13, this signal is received by the USB receiver 20 in the host-side controller 11. In response to this reception, the host SM 32 controls the SOF judgment circuit 31 to cause it to judge whether or not the received packet is a SOF packet.

If it is judged that the packet is not a SOF packet, the host SM 32 analyses the USB signal (packet) and then stores the packet in the transmission FIFO 21. Subsequently, the host SM 32 controls the modulator circuit 22 and the optical transmitter 23 to cause them to generate and transmit an optical signal including the received packet, to the device-side controller 12.

Note that, packets except for the SOF packet are related to the aforementioned transactions: IN transaction, OUT transaction, or SETUP transaction, and packets for data transfer and others. Note that, in the present system, as to each of the transactions, packet generation and packet transmission/reception are performed under the rules defined for the USB 2.0, and the explanation thereof will be omitted.

The optical signal having transmitted from the host-side controller 11 is received by the optical receiver 24 of the device-side controller 12. Then, the device SM 42 controls the demodulator circuit 25 to cause it to demodulate the packet in the optical signal. Thereafter, the device SM 42 controls the error detection circuit 28 to cause it to judge whether or not any error is in the demodulated packet (whether or not the packet is compliant with the USB standard).

Then, the device SM 42 stores, in the reception FIFO 26, only error-free packets of the received packets. Subsequently, after receiving and demodulating the whole of the packet, the device SM 42 controls the USB transmitter 27 to cause it to transmit the USB signal including this packet to the device 13 at a predetermined timing.

On the other hand, if it is judged that the packet received by the host-side controller 11 is a SOF packet, the host SM 32 abandons this packet without storing it in the transmission FIFO 21, and cancels transfer (repeat) to the device-side controller 12. Therefore, in the present system, the device-side controller 12 (device 13) receives no SOF packets from the host-side controller 11 (host 10).

Then, in the present system, the device SM 42 in the device-side controller 12, after negotiation with the device-side controller 12, controls the timer 29 to cause it to measure 125 μs (micro second) that is an interval of period between transmissions of the SOF packet in the HS mode. The device SM 42 generates the SOF packets at this interval and transmits the SOF packet to the device 13 at an interval of 125 μs. With this arrangement, in the present system, the SOF packet can be transmitted periodically to the device 13. Therefore, bus reset of the device 13 can be avoided without transmission of the SOF packet from the device-side controller 12, which allows the device 13 to maintain an active state.

When the USB signal including a packet is transmitted from the device 13 to the host-side controller 11, this signal is received by the USB receiver 20 in the device-side controller 12.

Then, the device SM 42 analyses the received USB signal (packet) and judges whether or not any error is in this data. Note that, the device SM 42 recognizes, as error packets, a packet not compliant with the USB standard and a packet which is not supposed to be transmitted from the device 13 (SOF packet, and other packet).

The device SM 42 stores only error-free packets in the transmission FIFO 21. Thereafter, the device SM 42 controls the modulator circuit 22 and the optical transmitter 23 to cause them to generate and transmit an optical signal including the received packet to the host-side controller 11.

The optical signal transmitted from the device-side controller 12 is received by the optical receiver 24 in the host-side controller 11. Then, the host SM 32 controls the demodulator circuit 25 to cause it to demodulate the packet in the optical signal. Thereafter, the host SM 32 controls the error detection circuit 28 to cause it to judge whether or not any error is in the demodulated packet (whether or not the packet is compliant with the USB standard).

Then, the host SM 32 stores, in the reception FIFO 26, only error-free packets of the received packets. Subsequently, after receiving and demodulating the whole of the packet, the host SM 32 controls the USB transmitter 27 to cause it to transmit the USB signal including this packet to the host-side controller 11 at a predetermined timing.

As described above, in the present system, the host SM 32 in the host-side controller 11, when having received the SOF packet having transmitted from the host 10 to the device 13, avoids transmission of this packet to the device side. Then, the device SM 42 in the device-side controller 12, after connection between the host 10 and the device 13 has been established, transmits the SOF packet to the device 13 at a predetermined interval.

Therefore, in the present system, it is not necessary to transmit the SOF packet between the controllers 11 and 12. Thus, a communication bandwidth between the controllers 11 and 12 of low communication speeds can be used only for packets other than the SOF packet. This prevents communication of these other packets from being interfered with by the SOF packet, which increases communication efficiency.

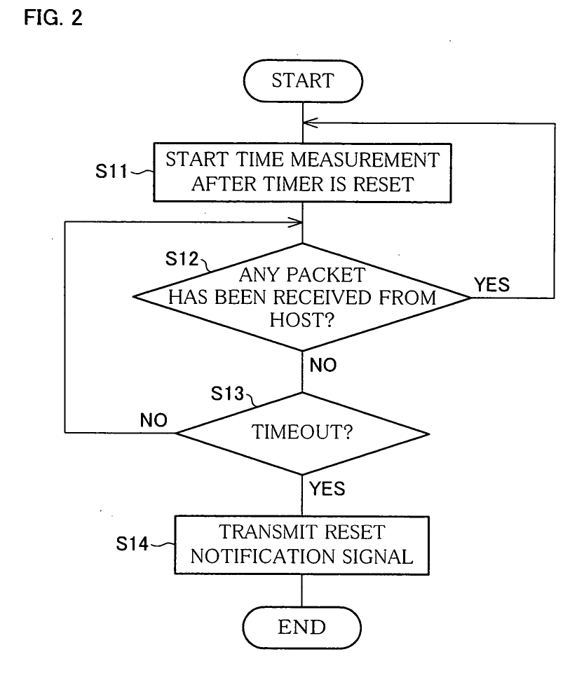

Here, in the present system, the following will describe a process for resetting a bus of the device 13. FIG. 2 is a flowchart (state transition diagram) illustrating operation of the host SM 32, with regard to this process, in the host-side controller 11. As illustrated in FIG. 2, the host SM 32, each time receiving the USB signal (packet) transmitted from the host 10 to the device 13, resets the timer 29 and measures an elapsed time from the instant when the timer 29 is reset (steps S11 and S12, hereinafter referred to as “S11 and S12”).

If it is judged that a time elapsed for measurement by the timer 29 reaches a predetermined period of time (e.g. 3 ms) (timeout; S13), the host SM 32 recognizes that the host 10 is about to reset the bus of the device 13. Thereafter, the host SM 32 controls the optical transmitter 23 to cause it to transmit a reset notification signal to the device-side controller 12 (S14).

The device SM 42 in the device-side controller 12, when having received the reset notification signal, recognizes that the host 10 is about to reset the bus. Then, the device SM 42 stops transmission of the SOF packet to the device 13. This facilitates resetting the bus of the device 13.

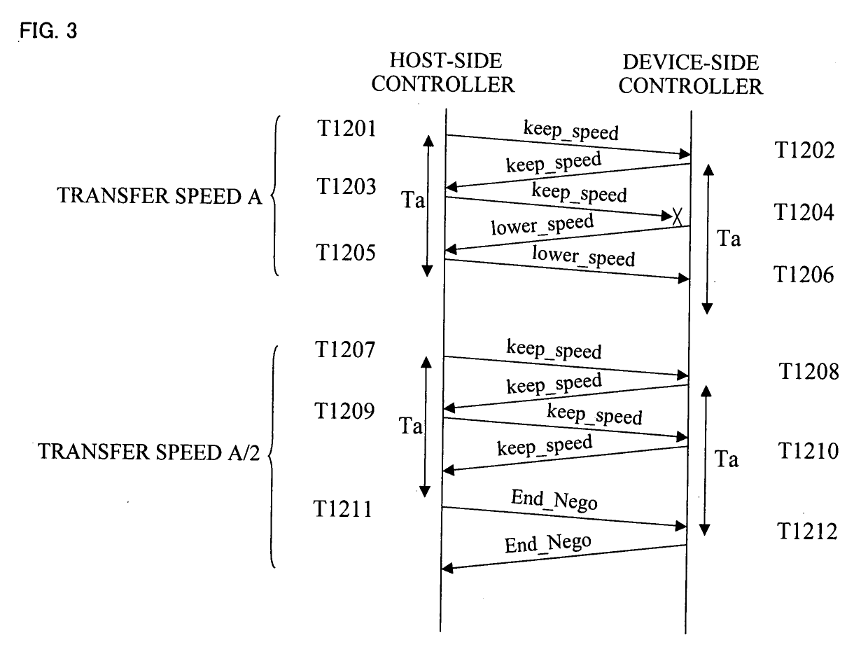

Next, the following will describe the aforementioned speed negotiation. The speed negotiation is a process for determining a data transfer speed in the optical wireless communications between the controllers 11 and 12. FIG. 3 is a timing chart illustrating an example of this process.

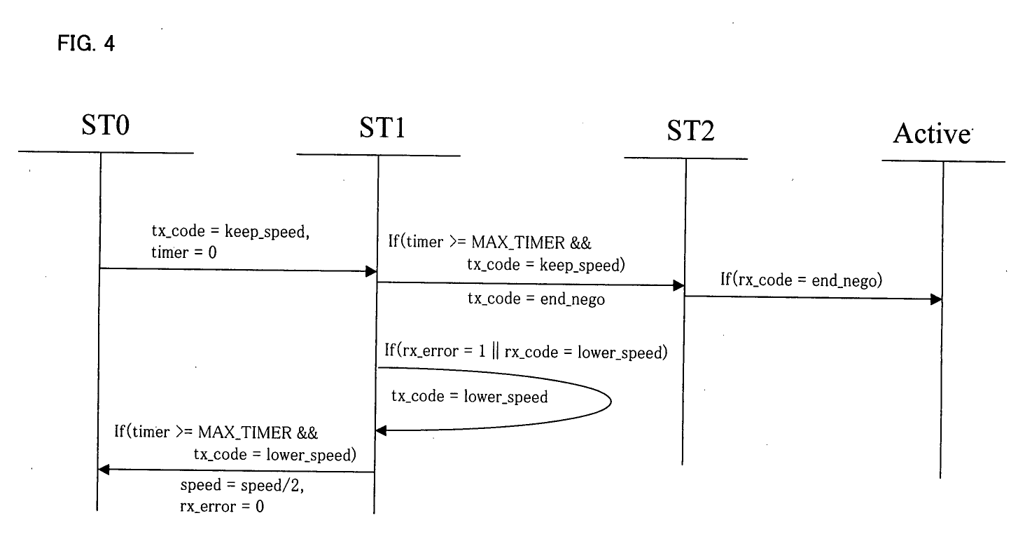

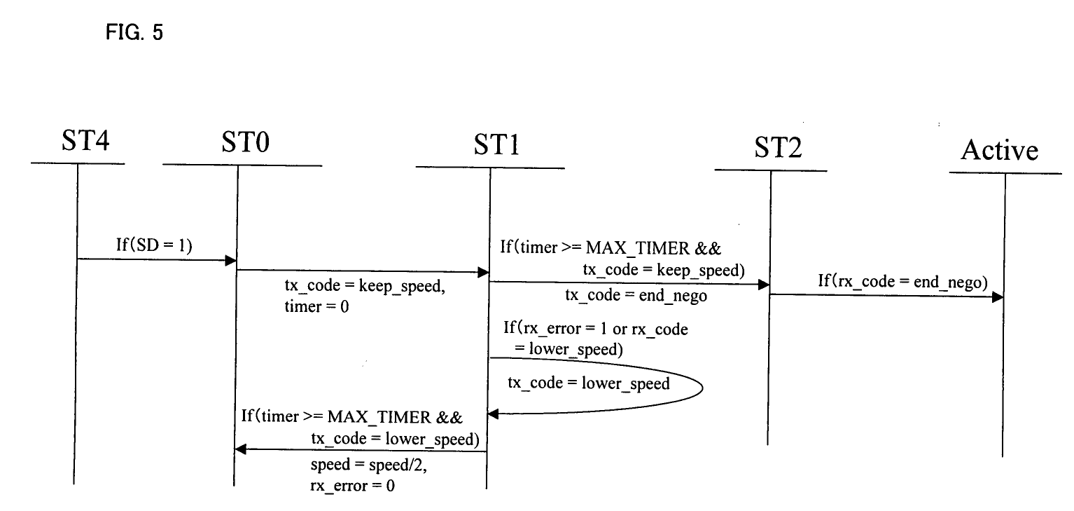

FIG. 4 is an explanatory diagram illustrating an operation of the SNSM 30 in the host-side controller 11 in this process. Further, FIG. 5 is an explanatory diagram illustrating operation of the SNSM 30 in the device-side controller 12 in this process.

The SNSM 30 in the host-side controller 11 controls the optical transmitter 23 at T1201 to cause it to initiate transmission of a keep_speed signal at a predetermined transfer speed A, and restarts the timer 29 (causes the timer 29 to start immediately after reset). Note that, the keep_speed signal is one of transmission codes (request signals) for determining a transfer speed and is a signal for requesting the other end (device-side controller 12) to maintain a current transfer speed.

Meanwhile, in the device-side controller 12, the optical receiver 24 having received this keep_speed signal first transmits a signal-detect signal to the SNSM 30. In response to the signal-detect signal, the SNSM 30 causes the timer 29 to restart and controls the optical transmitter 23 to cause it to initiate transmission of the keep_speed signal to host-side controller 11. Further, the SNSM 30 controls the demodulator circuit 25 and the error detection circuit 28 to cause them to judge whether or not any error is in the received keep_speed signal.

Then, as illustrated in FIG. 3, if the device-side controller 12 fails to normally receive the keep_speed signal transmitted at T1203 from the host-side controller 11, due to bit distortion on the optical wireless communication channel, the SNSM 30 in the device-side controller 12 transmits, at T1204, a lower_speed signal, instead of the keep_speed signal, to the host-side controller 11.

The lower_speed signal is one of request signals for determining a transfer speed and is a signal for requesting to the other end (host-side controller 11) to lower a transfer speed. In the host-side controller 11 having received the lower_speed signal, the SNSM 30 recognizes that a transfer to the device-side controller 12 would not be performed normally at a current transfer speed A. Then, the host-side controller 11 transmits a lower_speed signal to the device-side controller 12 (switches a transmission code to lower_speed).

The SNSM 30 in the device-side controller 12 judges that the host-side controller 11 has recognized the lower_speed signal having been transmitted from the device-side controller 12, by receiving the lower_speed signal from the host-side controller 11.

Then, since the lower_speed signals are transmitted and received at the point after a lapse of a predetermined period of time Ta, the respective SNSMs 30 in the controllers 11 and 12 lower the transfer speed A by half (to a transfer speed A/2), for example. That is, the SNSM 30 in the host-side controller 11 initiates transmission of a keep_speed signal at T1207 at the transfer speed A/2, and causes the timer 29 to restart.

Meanwhile, in response to the signal-detect signal from the optical receiver 24, the SNSM 30 in the device-side controller 12 initiates transmission of the keep_signal and causes the timer 29 to restart.

After a lapse of a predetermined period of time Ta with no errors detected in both the controllers 11 and 12, the respective SNSMs 30 in the controllers 11 and 12 initiate transmission and reception of End_Nego signals that are end-of-speed negotiation signals (end request). Then, the SNSM 30, when having received the End_Nego signal from the other end, ends the speed negotiation and shifts to the active state.

Here, referring to FIG. 4, the following will describe operation of the SNSM 30 in the host-side controller 11.

A state ST0 is a start state of speed negotiation. Here, the SNSM 30 in the host-side controller 11 sets the transmission code to keep_speed signal, and causes the timer 29 to restart, thereafter shifting to state ST1.

The state ST1 is a state where the speed negotiation is performed. The SNSM 30 in the host-side controller 11, when an error is in the reception code or the SNSM 30 has received the lower_speed signal from the other device (device-side controller 12), switches the transmission code to lower_speed.

Further, after a predetermined period of time Ta elapses, when the transmission code is the lower_speed signal, the SNSM 30 in the host-side controller 11 shifts to the state ST0, or when the transmission code is the keep_speed, the SNSM 30 in the host-side controller 11 shifts to state ST2.

Here, if the SNSM 30 shifts to the state ST0, the transfer speed is decreased to half of the current transmission speed, for example (A range (degree) of decrease in transfer speed can be set to a value that the user desires. Further, this range of decrease is stored beforehand in the SNSM 30). On the other hand, if the SNSM 30 shifts to the state ST2, the transmission code is switched to End_Nego signal. This state ST2 is a state where completion of the speed negotiation is checked. Upon reception of the End_Nego signal from the other device (device-side controller 12), the SNSM 30 completes the speed negotiation and shifts to the active state.

Next, referring to FIG. 5, the following will describe operation of the SNSM 30 in the device-side controller 12. Operations in the states ST0, ST1, and ST2 are the same as those of the SNSM 30 in the host-side controller 11.

State ST4 that is a preceding state of the state ST0 is a state where it is judged whether or not the request signal has been received from the host-side controller 11. When having received the signal-detect signal from the optical receiver 24 (or other reception signal detection circuit), the SNSM 30 shifts to the state ST0.

Note that, the foregoing keep_speed signal, lower speed signal, and End_Nego signal may be composed of packets (character string having a specific format) or specific characters.

Further, the above description assumes that speed negotiation is performed after checking of a communication mode (speed) between the host 10 and the device 13. However, speed negotiation may be performed at any time before start of communications between the host 10 and the device 13.

Still further, the above description assumes that speed negotiation is performed in the state where connections between the host 10 and the host-side controller 11 and between the device-side controller 12 and the device 13 are made using the USB cables. However, the present embodiment is not limited to this arrangement. The speed negotiation can be performed before connections between the host 10 and the host-side controller 11 and between the device-side controller 12 and the device 13 are made using the USB cables, provided that the controllers 11 and 12 are ready for communications.

Yet further, in the present embodiment, the host SM 32 avoids transmitting, to the device side, the SOF packet received from the host 10, and the device SM 42 generates the SOF packet on its own initiative and transmits it to the device 13 at a predetermined interval. However, in the above speed negotiation, the present embodiment is not limited to this arrangement if a speed of optical wireless communications between the controllers 11 and 12 can be set to a speed (480 Mbps) which is equal to a speed of communications using the USB cable.

That is, in such a case, the host SM 32 may directly transmit, to the device side, the SOF packet having received from the host 10. Then, the device SM 42 may be arranged so as to transmit, to the device 13, the SOF packet having received from the device-side controller 12.

In such a case, even if transmission and reception of the SOF packet is performed between the controllers 11 and 12, a proportion of the SOF packet in the communication bandwidth during this transmission and reception can be reduced to about a proportion of the SOF packet in the communication bandwidth in using the USB cable. Therefore, no decrease in communication efficiency of other packets occurs due to transmission and reception of the SOF packet. However, even in this case, it may be arranged such that transmission of the SOF packet between the controllers 11 and 12 is avoided.

Further, after the speed negotiation as described above, at least one of the host SM 32 and the device SM 42 preferably calculates, using the error detection circuit 28, an error rate in packet transmission and reception between the controllers 11 and 12. Here, the error rate (a rate of error occurrence) is a value obtained by division of the number of times errors occur by the number of times transmission and reception are performed.

In addition, when this error rate is equal to or more than a predetermined value, the host SM 32 and the device SM 42 preferably control the SNSMs 30 to cause them to decrease a communication speed between the controllers 11 and 12. This reduces a rate of errors (error rate) caused by too high a communication speed.

Further, generally, in the USB system, in the case where communications using the USB cable are half-duplex communications, data transfer is adjusted such that the host transmits, to the device, the SOF packet in preference to other packets (Transmission of the SOF packet in preference to other packets is defined in the USB specification.). Here, the half-duplex communications is communications where one of the host and the device occupies a communication channel.

However, as in the present system, if a data transfer channel has a part of a low transfer speed (part between the controllers 11 and 12), the SOF packet cannot be transmitted for transmission of other packets, in some cases, since the host cannot favorably adjust data transfer (In some cases, the SOF packet cannot be transmitted to the device.).

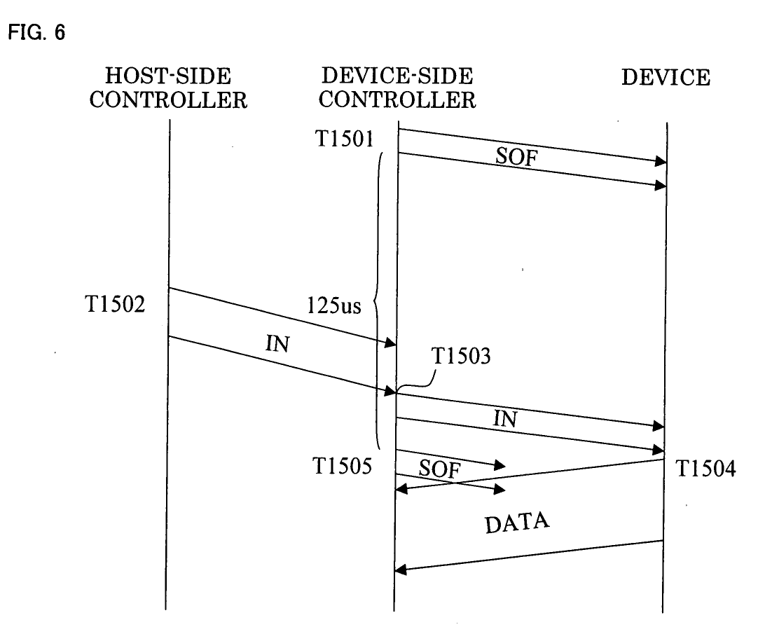

FIG. 6 is a timing chart illustrating an example of such a case (IN transaction). First, at a timing 1501 (hereinafter referred to as T1501), the device SM 42 in the device-side controller 12 transmits the SOF packet to the device 13.

Then, at T1502, the host SM 32 in the host-side controller 11 transmits an IN packet to the device-side controller 12. The device SM 42 in the device-side controller 12, after completion of reception of the IN packet, transmits it to the device 13 (T1503).

Here, the device SM 42 is set so as to wait for the completion of reception of the IN packet and repeat the IN packet to the device 13. This aims to prevent data loss caused when the IN packet that the device-side controller 12 has received from the host-side controller 11 on a low-speed communication channel (optical wireless communications) is repeated from the device-side controller 12 to the device 13 on a high-speed communication channel (USB cable).

Further, as illustrated in FIG. 6, when having received the IN packet, the device 13 transmits a DATA packet to the device-side controller 12 at T1504.

At T1505, the device SM 42 attempts to transmit the SOF packet to the device 13 since a timing at which the SOF packet is to be transmitted has come. However, at T1505, the DATA packet is in transmission by the device 13. Because of this, the device SM 42 cannot transmit the SOF packet to the device 13, with the USB cable for half-duplex communications.

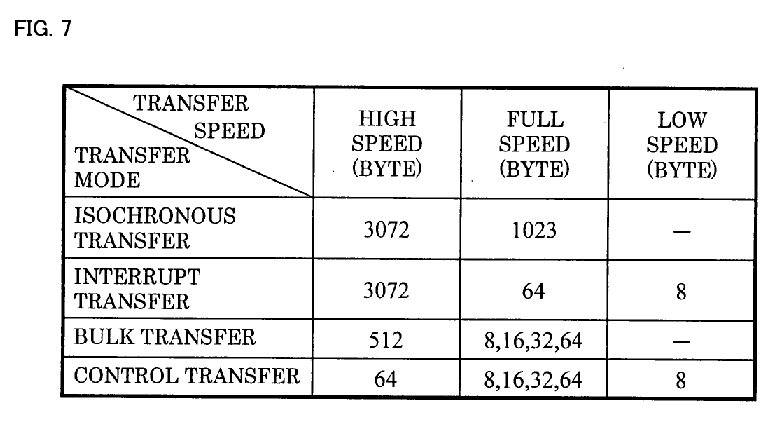

The following will describe how to prevent a failure of transmission of the SOF packet during execution of the IN transaction. That is, as described above, the device SM 42 determines, using the timer 29, a timing for transmitting the SOF packet (SOF packet transmission timing) to the device 13. Further, a maximum length of the DATA packet sent back from the device 13 in response to the IN packet transmitted to the device 13 takes any of values illustrated in FIG. 7.

On the basis of these values, the device SM 42 calculates such a range of a timing for transmitting the IN packet (IN packet transmission timing) to the device 13 (value of the timer 29) that the SOF packet transmission timing falls outside the period during which the device SM 42 receives the DATA packet from the device 13 and transmits the DATA packet to the host-side controller 11 and the period during which the device-side controller 12 (device SM 42) transmits an ACK packet to the device 13 (Hereinafter, this range is referred to as “IN packet transmittable range”.). That is, the device SM 42 is set so as to calculate the IN packet transmittable range and transmit the IN packet to the device 13 within the obtained time range. This can avoid interference with transmission of the SOF packet by other packets transmitted and received with respect to the device 13.

Note that, the IN packet transmittable range is a time range in which transmission of the IN packet is started and is a time range in which the SOF packet transmission timing falls outside the period “from transmission of the IN packet from the device-side controller 12 to the device 13 to the device-side controller 12's completion of reception of the DATA packet of a maximum length from the device 13.

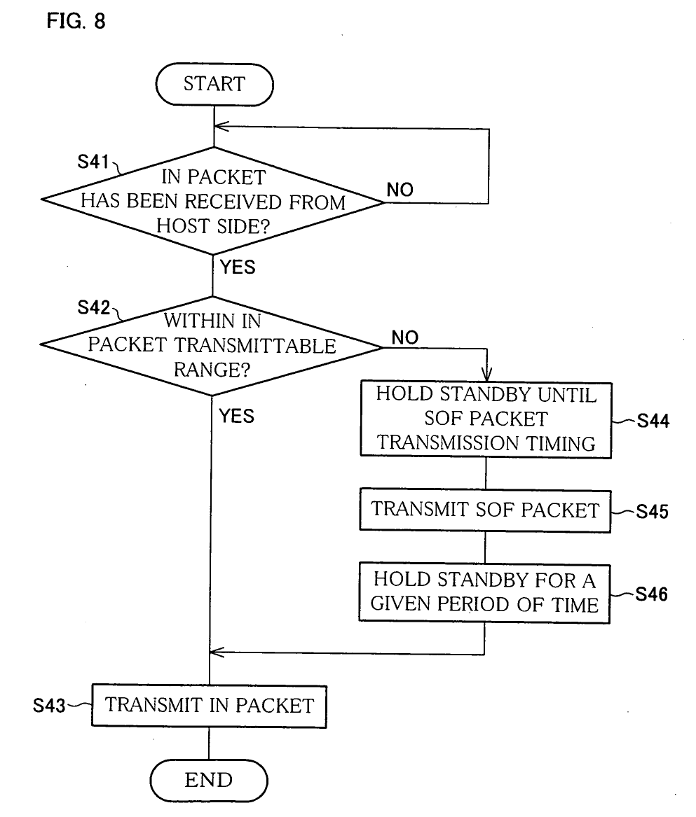

FIG. 8 is a flowchart illustrating a flow of operation of the device SM 42 in the IN transaction. As illustrated in FIG. 8, when having received the IN packet from the host-side controller 11 (S41), the device SM 42 judges whether or not a value that the timer 29 takes is within the IN packet transmittable range (S42). Then, when the device SM 42 judges that the value is within the IN packet transmittable range, the device SM 42 transfers the IN packet to the device 13 (S43) to finish the process.

On the other hand, in S42, when the device SM 42 judges that the value is not within the IN packet transmittable range, the device SM 42 holds standby until the SOF packet transmission timing (S44). Then, the device SM 42 transmits the SOF packet (S45) and holds standby for a given period of time (S46). Thereafter, the device SM 42 judges to be in the IN packet transmittable range and transmits the IN packet to the device 13 (S43) to finish the process.

The foregoing process enables an excellent transmission of the SOF packet from the device-side controller 12 (device SM 42) to the device 13 in the IN transaction, without interference by transmission and reception of other packets. Note that, after S46, the device SM 42 may return the process to S42 to check again that the device SM 42 is within the IN packet transmittable range. Alternatively, without standby in S46, the device SM 42 may immediately transmit the IN packet (or return to S42).

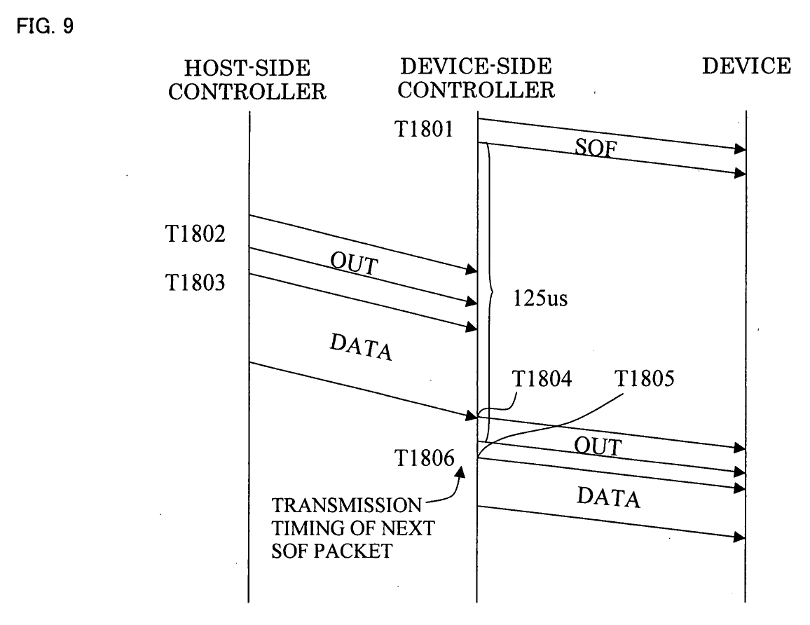

Note that, the foregoing problem involving transmission of the SOF packet occurs not only in the IN transaction but also in OUT transaction. FIG. 9 is a timing chart illustrating an example where the SOF packet cannot be transmitted in the OUT transaction. As illustrated in FIG. 9, at T1801, the device SM 42 in the device-side controller 12 transmits the SOF packet to the device 13.

Then, at T1802 and T1803, the host SM 32 in the host-side controller 11 transmits an OUT packet and a DATA packet to the device-side controller 12. The device SM 42 in the device-side controller 12, after completion of reception of these packets, transmits them to the device 13 (at T1804 and T1805).

Here, the device SM 42 is set so as to wait for the completion of reception of the OUT packet and the DATA packet and repeat them to the device 13. This aims to prevent data loss caused when the OUT packet and the DATA having been received by the device-side controller 12 from the host-side controller 11 on a low-speed communication channel (optical wireless communications) is repeated from the device-side controller 12 to the device 13 on a high-speed communication channel (USB cable).

At T1806, a timing at which the SOF packet is to be transmitted comes. However, at T1806, the DATA packet is in transmission by the device SM 42 to the device 13, so that the device SM 42 cannot transmit the SOF packet.

The following will describe how to prevent a failure of transmission of the SOF packet during execution of the OUT transaction. That is, as described above, the device SM 42 determines, using the timer 29, a timing for transmitting the SOF packet (SOF packet transmission timing) to the device 13. Further, a maximum length of the DATA packet transmitted from the device-side controller 12 to the device 13 takes any of values illustrated in FIG. 7.

On the basis of these values, the device SM 42 calculates such a range of a timing for transmitting the OUT packet and the DATA packet to the device 13 (a value of the timer 29) that the SOF packet transmission timing falls outside the period during which the device SM 42 transmits the OUT packet and the DATA packet and the period during which the device SM 42 receives an ACK packet from the device 13 (Hereinafter, this time range is referred to as “OUT packet transmittable range”.). That is, the device SM 42 calculates the OUT packet transmittable range and is set so as to transmit the OUT packet and the DATA packet to the device 13 in this time range. This can avoid interference with transmission of the SOF packet by other packets transmitted and received with respect to the device 13. That is, the device SM 42 is set so as to calculate the OUT packet transmittable range and transmit the OUT packet and the DATA packet to the device 13 in the obtained range. This allows the device SM 42 to avoid interference with transmission of the SOF packet by other packets transmitted and received with respect to the device 13.

Note that, the OUT packet transmittable range is a time range in which transmission of the OUT packet is started and is a time range in which the SOF packet transmission timing falls outside the period during which “the device-side controller 12 transmits the OUT packet to the device 13, transmits the DATA packet of a maximum length to the device 13, and receives the ACK packet from the device 13”.

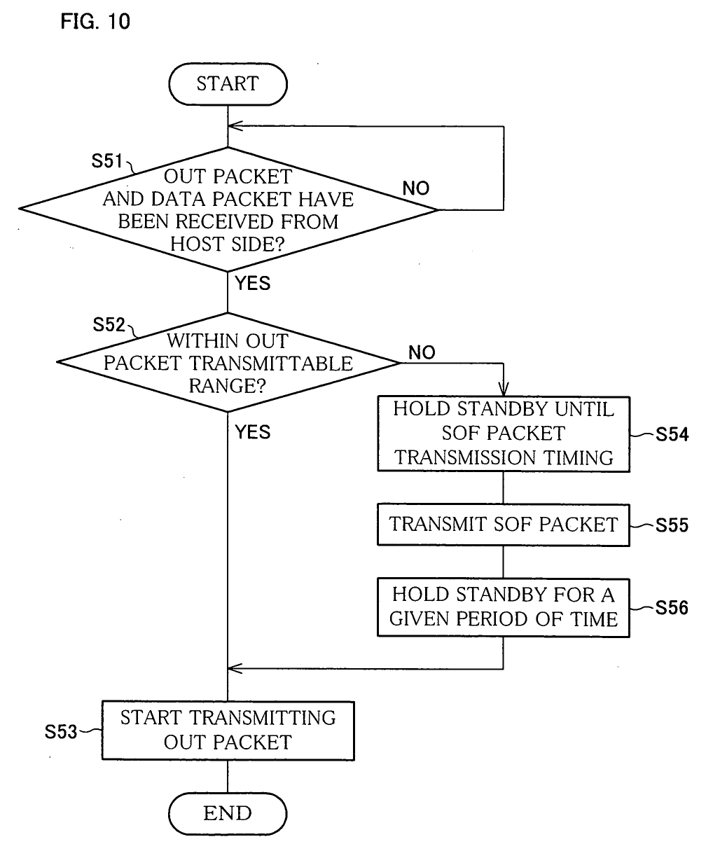

FIG. 10 is a flowchart illustrating a flow of operation of the device SM 42 in the OUT transaction. As illustrated in FIG. 10, when having received the OUT packet and the DATA packet from the host-side controller 11 (S51), the device SM 42 judges whether or not a value that the timer 29 takes is within the OUT packet transmittable range (S52). Then, when the device SM 42 judges that the value is within the OUT packet transmittable range, the device SM 42 transfers the OUT packet and the DATA packet to the device 13 (S53) to finish the process.

On the other hand, in S52, when the device SM 42 judges that the value is not within the OUT packet transmittable range, the device SM 42 holds standby until the SOF packet transmission timing (S54). Then, the device SM 42 transmits the SOF packet (S55), holds standby for a given period of time (S56). Thereafter, the device SM 42 judges to be in the OUT packet transmittable range and transmits the OUT packet and the DATA packet to the device 13 (S53) to finish the process.

The foregoing process enables an excellent transmission of the SOF packet from the device-side controller 12 (device SM 42) to the device 13 in the OUT transaction, without interference by transmission and reception of other packets. Note that, after S56, the device SM 42 may return the process to S52 to check again that the device SM 42 is within the OUT packet transmittable range. Alternatively, without standby in S56, the device SM 42 may immediately transmit the OUT packet and the DATA packet (or return to S52).

Note that, before transmission to the device 13, the device SM 42 can know a packet length (size) of the DATA packet. Therefore, the OUT packet transmittable range may be set to be a time range in which transmission of the OUT packet is started and is a time range in which the SOF packet transmission timing falls outside the period during which “the device-side controller 12 transmits the OUT packet to the device 13, transmits to the device 13 the DATA packet having been received from the host-side controller 11, and receives the ACK packet from the device 13”. In this case, the device SM 42 calculates the OUT packet transmittable range each time the OUT transaction is performed. However, this enables setting of a suitable time range, which can prevents a time-wasting standby for transmission of the OUT packet and the DATA packet. This increases transmission efficiency.

Further, the foregoing problem involving transmission of the SOF packet also occurs in SETUP transaction. The SETUP transaction is a process of transmitting a SETUP packet, instead of the OUT packet, to the device 13 in the OUT transaction. Therefore, the process illustrated in FIG. 10 enables an excellent transmission of the SOF packet in the SETUP transaction.

Further, in the present embodiment, the host SM 32 does not repeat the SOF packet to the device-side controller 12. Instead, the device SM 42 transmits the SOF packet to the device 13 at a predetermined interval (125 μs).

However, the present invention is not limited to this arrangement. The following arrangement may be adopted: upon reception of the SOF packet from the host 10, the host SM 32 transmits, to the device-side controller 12, a SOF reception notification signal that indicates reception of the SOF packet. In this case, the device SM 42 may be set so as to transmit the SOF packet to the device 13 at a timing of receiving the SOF reception notification signal. Here, examples of the SOF reception notification signal may include specific characters of 8B10B and another type of packet.

In this arrangement, the host SM 32 transmits, to the device-side controller 12, the SOF reception notification signal of which transfer time is much shorter than that of the SOF packet, thereby transferring the SOF packet transmission timing to the device SM 42 in the device-side controller 12.

This allows a communication speed (communication time) in optical wireless communications of the SOF packet between the controllers 11 and 12 to be increased (shortened) to “the extent that the SOF packet is transmitted between the controllers 11 and 12 which are connected using the USB cable”.

Therefore, this arrangement also allows the bus of the device 13 to be maintained in an active state and prevents decrease in communication efficiency between the host and the device, caused by transmission of the SOF packet. Note that, this arrangement eliminates the need for provision of the timer 29 in the device-side controller 12.

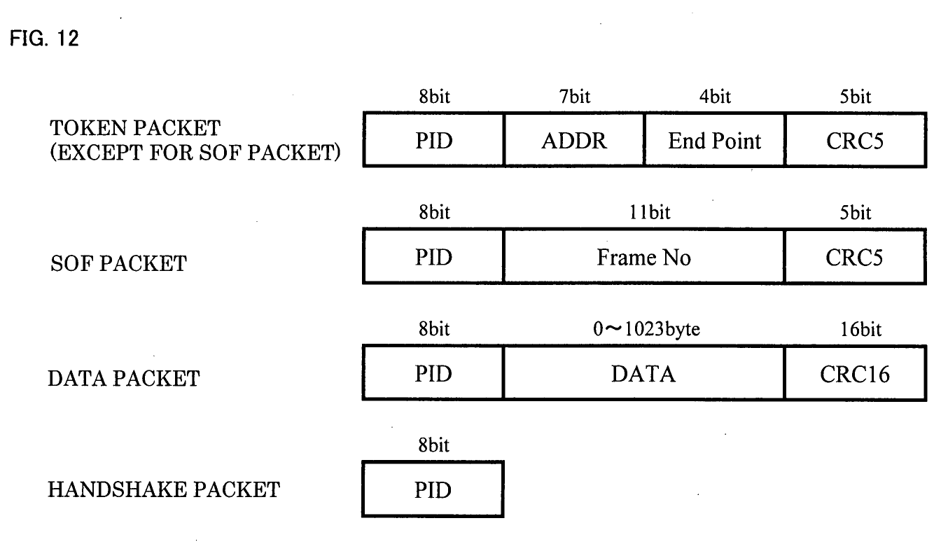

Further, in generating the SOF packet to be transmitted to the device 13, the device SM 42 preferably generates the SOF packet according to a predetermined rule. For example, it is preferable that the device SM 42 correctly sets a frame number (FrameNo) in a format of the SOF packet, illustrated in FIG. 12. This frame number, in the HS mode, takes the same number in eight consecutive packets and, in the ninth packet, takes a number increased by one from the previous number. In the FS mode, the frame number takes a number increased by one with each packet increasing.

Note that, in the present system, there is the possibility that the frame number of the SOF packet transmitted from the device-side controller 12 to the device 13 might not be identical with the frame number of the SOF packet transmitted from the host 10. However, as to the SOF packet received by the device 13, a reception timing thereof is important. Difference of the frame number from the SOF packet transmitted from the host 10 is no problem as far as communications are performed in accordance with the above rule defined in the USB 2.0.

Further, in the present embodiment, the host 10 and the device 13 communicate each other in the HS mode. However, the present embodiment may be set so that the host 10 and the device 13 communicate each other in another mode (LS mode, FS mode). This arrangement also avoids a bandwidth of communications between the controllers 11 and 12 from being narrowed by transmission of the SOF packet.

Further, in the present embodiment, the host SM 32 in the host-side controller 11, when it is recognized that the received packet is a SOF packet, abandons this packet without storing it in the transmission FIFO 21. However, the device-side controller 12 may be set so as to store the received packet in the transmission FIFO 21 and then judge whether or not this packet is a SOF packet. In this case, when it is recognized that the receive packet is a SOF packet, the host SM 32 abandons this packet from the transmission FIFO 21.

Further, in the present embodiment, data transfer speed in optical wireless communications between the controllers 11 and 12 is 100 Mbps. However, the present invention is not limited to this speed. The transfer speed between the controllers 11 and 12 may be any speed (It may be higher than, lower than, or equal to the transfer speed in communications using the USB cable.). Regardless of this transfer speed, the present system allows for increase in communication efficiency of other packets since the SOF packet is not transmitted and received between the controllers 11 and 12.

Further, in the present embodiment, the controllers 11 and 12 are connected through optical wireless communications. However, the present invention is not limited to this arrangement. The controllers 11 and 12 may be communicated each other by means of an optical cable. Note that, the use of the optical cable allows for long-distance packet transmissions. The optical wireless communications (free-space optical communications) are cable-free communications, thus increasing convenience.

Further, as to a communication scheme between the controllers 11 and 12, either half-duplex communications or full-duplex communications may be adopted. Here, the full-duplex communications are communications where transmission from the host to the device and transmission from the device to the host can be performed simultaneously. Adoption of the full-duplex communications causes a continuous light emission of the optical transmitter 23 which is realized by a light-emitting diode or laser diode. This eliminates the need for addition of a preamble to a packet, thus increasing communication efficiency (use efficiency) of a communication channel.

Here, the optical transmitter 23 is caused to continuously emit light in the full-duplex communications to immediately repeat a packet that the USB receiver 20 has received from the host 10 or the device 13.

Further, a continuous light emission of the optical transmitter 23 facilitates connection/disconnection between the controllers 11 and 12. That is, in the case of the half-duplex communications, if the optical receiver 24 receives no light for a given period of time, it is judged that the controllers 11 and 12 are disconnected from each other. On the other hand, in the case of the full-duplex communications, the optical transmitter 23 continuously emits light in a connection state, and the optical receiver 24 in the other controller continuously receives light. Then, for the disconnection between them, the optical transmitter 23 stops light emission. This allows judgment of the disconnection at that point in time when the optical receiver 24 receives no light. This shortens a time required for the disconnection, as compared to the half-duplex communications.

Further, the controllers 11 and 12 may be connected through wireless communications using normal radio waves. In this case, it is preferable that schemes for modulation of the modulator circuit 22 and demodulation of the demodulator circuit 25 are properly set. Further, the optical receiver 24 is a reception antenna which receives ratio waves.

The preamble is a signal necessary for clock synchronization by a clock data recovery circuit (not shown) in the packet-receiving end. Normally, a continuous “1010” pattern is used. A period for the preamble is a period during which the DATA packet cannot be transmitted. Therefore, the preamble causes a waste of time. In the case of the full-duplex communications, the host and the device continuously transmits signals. This eliminates the need for clock synchronization for each packet. That is, the preamble is not necessary. Therefore, in the full-duplex communications, transfer efficiency is increased.

Further, in the present system, the device SM 42 in the device-side controller 12, when having received a reset notification signal from the host-side controller 11, stops transmission of the SOF packet. In this case, the present system is in the same state as the case when the bus reset is performed at the time of connection of the device 13. Therefore, the device SM 42, when having received CHIRP transmitted from the device 13 to the host 10, may transmit it to the host-side controller 11 and transmit, to the device 13, CHIRP which is supposed to be transmitted from the host 10 (host-side controller 11). This completes negotiation at the time of the connection, so that the device SM 42 resumes transmission of the SOF packet.

Therefore, a device-side controller of the present invention can be expressed as a device-side controller, provided to a device of a USB system, which relays communications between the host and the device, the device-side controller comprising: a device-side control section which, when having received CHIRP transmitted from the device to the host, transmits the CHIRP to the host side and transmits, to the device, CHIRP which is supposed to be transmitted from the host.

Further, in the present embodiment, connections between the host-side controller 11 and the host 10 and between the device-side controller 12 and the device 13 are made using the USB cables. However, the present invention is not limited to this arrangement. The host-side controller 11 may be connected to a downstream port of a USB hub connected to the host 10. The host-side controller 11 may be a part of the hose 10 or the USB hub.

The device-side controller 12 may be connected via the USB cable to an upstream port of the USB hub. Further, the device-side controller 12 may be a part of the device or the USB hub.

In the present system, the host SM 32 and the device SM 42 are actually similar members, and the host-side controller 11 and the device-side controller 12 have substantially the same arrangement except for the SOF judgment circuit 31. Therefore, the device-side controller 12 may have the same arrangement as the host-side controller 11 (arrangement including the SOF judgment circuit 31). In this case, the SOF judgment circuit 31 in the device-side controller 12 is not used. However, just providing one type of controller in both the host 10 and the device 13 allows establishment of the present system.

Further, in the present embodiment, the controllers 11 and 12 include the error detection circuits 28, respectively. However, the arrangement in which errors in the transmitted packet are not detected does not need the error detection circuit 28. Further, the host SM 32 and the device SM 42 may detect errors in the packet.

Further, in the present embodiment, the host-side controller 11 includes the timer 29. However, the present invention is not limited to this arrangement. If the host SM 32 does not use the timer 29 (e.g. in an arrangement in which the reset notification signal is not transmitted from the host-side controller 11 to the device-side controller 12), the host-side controller 11 does not need to include the timer 29.

Further, in the present embodiment, the host 10 is a personal computer. However, the present embodiment is not limited to this arrangement. The host 10 may be any device, provided that the host 10 can use the device 13 and can be a master in the USB.

Further, in the present embodiment, the controllers 11 and 12 include the SNSMs 30, respectively. However, the present invention is not limited to this arrangement. The controllers 11 and 12 do not need to include the SNSMs 30, respectively, in the arrangement in which the foregoing speed negotiation is not performed and a communication speed between the controllers 11 and 12 is uniform.

Further, in the present embodiment, after connection between the host 10 and the device 13 is established, the device SM 42 in the device-side controller 12 transmits the SOF packet to the device 13. In addition, the host SM 32 in the host-side controller 11, when having received the SOF packet transmitted from the host 10 to the device 13, avoids transmission of this SOF packet to the device-side controller 12.

However, the present embodiment is not limited to this arrangement. As with a normal USB system, the present system may be set such that the host SM 32 in the host-side controller 11 repeats, to the device-side controller 12, the SOF packet transmitted from the host 10, and the device SM 42 in the device-side controller 12 repeats the SOF packet to the host 10.

That is, in the present system, communications between the host 10 and the host-side controller 11 and between the device-side controller 12 and the device 13 are performed in the high speed mode (in the HS mode, 480 Mbps) which is a USB native maximum speed, and communications between the controllers 11 and 12 are performed through optical communications (optical wireless communications or communications using the optical cable) of 100 Mbps that is lower than the USB native maximum speed.

Here, assume that a data transfer speed in the optical communications between the controllers 11 and 12 is 480 Mbps. In this case, when a modulation scheme of 8B10B, for example, is used, an optical transmitter and an optical receiver (optical transceiver) each having a bandwidth of 480×10/8=600 Mbps are necessary. To obtain such an optical transmitter, the use of an LD (laser diode) is necessary.

On the other hand, assume that a data transfer speed in the optical communications between the controllers 11 and 12 is 100 Mbps. In this case, the optical transmitter 23 can be realized by using LED (light-emitting diode). If comparisons are made between the LD and the LED, the LED is less expensive by far than the LD. Therefore, decrease of a speed in the optical communications between the controllers 11 and 12 realizes the controllers 11 and 12 (optical transmitters 23) arranged at low cost. Further, adoption of optical communications avoids limitations involving the use of the USB cables, such as cable length.

Further, it is preferable that members performing data communications between the controllers 11 and 12 are the optical transmitter 23 and the optical receiver 24 alone, and ports for the data communications (communication terminals) are optical ports, i.e. the optical transmitter 23 and the optical receiver 24, alone (Metal ports are not used). Also, it is preferable that the controllers 11 and 12 are integral with the host 10 and the device 13, respectively. Such an arrangement significantly decreases a bandwidth required for the controllers 11 and 12 from 600 Mbps to 100 Mbps. This allows for manufacture of the controllers 11 and 12 in an inexpensive manufacture process.

Note that, when a device of low data transfer speed (e.g. flash memory; about 50 Mbps) is used as the device 13, a time required for completion of the transaction highly depends on a transfer speed of the device 13. Therefore, it can be said that if the data transfer speed between the controllers 11 and 12 is faster than a transfer speed of the device 13, the transfer speed of the device 13 does not have a significant impact on the time required for completion of the transaction.

Further, even when a communication channel between the controllers 11 and 12 is another communication channel not using light (e.g. wireless communications using radio waves), a decreased transfer speed between controllers 11 and 12 realizes cost reduction of the controllers 11 and 12. Therefore, a USB system of the present invention can be expressed as a USB system comprising; a host; a device; a host-side controller, provided to the host, which relays communications between the host and the device; and a device-side controller, provided to the device, which relays communications between the host and the device, wherein a data transfer speed between the controllers is lower than a data transfer speed in the high speed mode of the USB 2.0.

Also, a USB system of the present invention can be expressed as a USB system including: a host-side controller, provided to a host of the USB system, which relays packets transmitted and received between an external entity and the host; and a device-side controller, provided to a device of the USB system, which relays packets transmitted and received between an external entity and the device, and the USB system is set such that the host-side controller, when having received the SOF packet transmitted from the host to the device, avoids transmission of this packet to the device side, and the device-side controller transmits the SOF packet to the device at a predetermined interval.

Further, in the foregoing arrangement, all operations of the device-side controller 12 are performed under control of the device SM 42. However, the present invention is not limited to this arrangement. The device SM 42 may be substituted by an information processor capable of reading out a program for performing the operations of the device-side controller 12, which is stored in a storage medium.

Similarly, in the foregoing arrangement, all operations of the host-side controller 11 are performed under control of the host SM 32. The host SM 32 may be substituted by an information processor capable of reading out a program for performing the operations of the host-side controller 11, which is stored in a storage medium.

In this arrangement, an arithmetic unit (CPU or MPU) reads out a program stored in a storage medium and executes processing. Therefore, it can be said that the program itself realizes the processing.

Here, as the foregoing information processor, not only a general computer (workstation and personal computer), but also a function expansion board and a function expansion unit provided in the computer can be used.

Further, the foregoing program is program codes (execute form program, intermediate code program, source program, or the like) of software which realizes the processing. This program may be used singly or in combination with other program (such as OS). This program may be a program that, after being read out from a storage medium, is temporarily stored in memory (such as RAM), and then is read out from the memory for execution.

Further, a storage medium storing the program therein may be easily separated from the information processor or fixed (mounted) to the information processor. Alternatively, the storage medium may be connected as an external storage device to the information processor.

Examples of such a storage medium includes: a magnetic tape medium such as a video tape and cassette tape; a magnetic disk medium such as floppy® disk and hard disk; an optical disk (magnetoptic disk) such as CD-ROM, MO, MD, DVD, and CD-R; a memory card such as an IC card and optical card; or a semiconductor memory such as a mask ROM, EPROM, EEPROM, and flash ROM. Further, the storage medium may be connected to the information processor over a network (Intranet, Internet, or the like). In this case, the information processor obtains a program by downloading the program over the network. That is, the above program may be obtained through a transmission medium (medium that holds a program in a flowing manner) such as a network (which is connected to a wired line or wireless line). Note that, a download program is preferably stored in advance in the information processor (or transmission device and reception device).

Further, the present invention can be realized as a communication controller 100 including functions as the host-side controller 11 and the device-side controller 12.

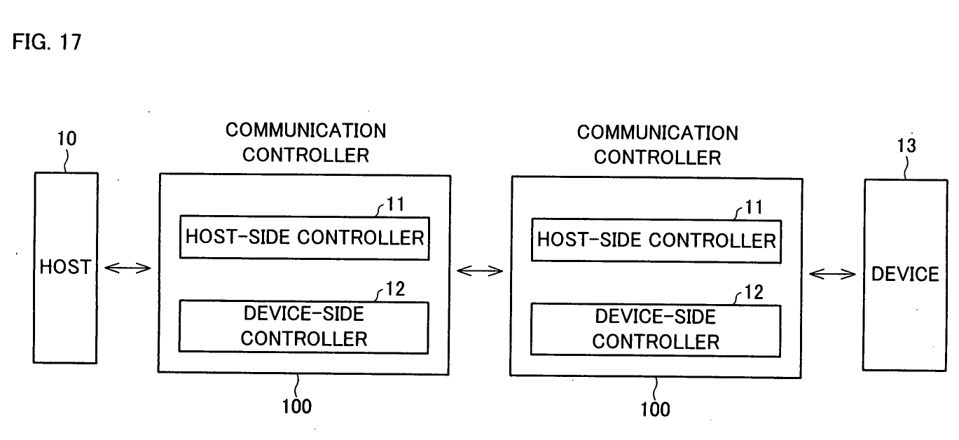

As illustrated in FIG. 17, the communication controller 100 has a function as the host-side controller 11 and a function as the device-side controller 12. With controller 100 can be used as the host-side controller 11 and as the device-side controller 12.

That is, the communication controller 100 brings the effect obtained by the host-side controller 11 and the effect obtained by the device-side controller 12.

Therefore, just by providing one type of the communication controller 100 to each of the host 10 and the device 13, it is possible to establish a system which is functionally equivalent of the system including the host-side controller 11 and the device-side controller 12. That is, such a system can be established without preparation of two types of controllers, so that it is possible to simplify establishment of the system.

Further, the communication controller 100 can be used in a system where various information devices connected to a USB system function as either the host 10 or the device 13, depending on situations where the devices are used. Note that, examples of such a USB system include USB-OTG (USB-On-The-Go) that has been standardized recently.

The USB-OTG is a standard which allows devices (peripherals) conventionally connected to a host (personal computer, etc.) via a USB system to have a function as a host. Therefore, a USB system according to the USB-OTG standard allows for data transfer through connection between the devices, which is impossible in the USB1.x and the USB 2.0.

In the USB1.x and the USB 2.0 standards, the function of the host side and the function of the device side are fixed. That is, data exchange under these standards is performed in the state where the device 13 (digital camera, printer, or others) as a USB function is connected to the host 10 as a personal computer.

However, the USB-OTG standard eliminates the need for a personal computer (USB host), which has been needed in the conventional USB system. That is, the USB-OTG standard allows for data transmission and reception between USB devices without the personal computer (USB host), thus increasing convenience. In the USB-OTG, USB devices can operate as either a host or a device, depending on the type of a cable connector coupled.

The USB-OTG, as with the USB 2.0, supports the following transfer speeds: LS (1.5 Mbps); FS (12 Mbps); and HS (480 Mbps). Further, USB-OTG-compliant devices can operate as either a USB host or a USB function (device).

Further, to the USB-OTG standard, a new type of connector called mini-AB is added. To the mini-AB, both of a cable having a mini-A plug and a cable having a is connected to the mini-A plug, the device operates as a USB host. When the USB-OTG device is connected to the mini-B plug, the device operates as a USB function.

Further, to the USB-OTG standard, a mechanism of dynamically changing between functions of the USB host and the USB function in a state where the USB-OTG devices are connected through a cable under a new protocol called HNP (Host Negotiation Protocol) has been added. In other words, in the USB-OTG, which of connected devices operates as a USB host or a USB function is determined depending on the type of a cable connector or HNP (Host Negotiation Protocol) defined in the USB-OTG.

That is, in the USB-OTG, roles of the USB host and the USB function (device) are not fixed, but their roles are interchangeable in accordance with a direction in which data are transmitted. Similarly, roles of the host-side controller 11 and the device-side controller 12 are not fixed, but their roles are interchangeable in accordance with a direction in which data are transmitted.

Therefore, to be compliant with this USB-OTG, one communication controller 100 has both functions of the host-side controller 11 and the function-side controller 12.

For example, with a USB system built using the communication controller 100, a digital camera and a printer are directly connected to each other, so that the digital camera can function as the host 10 and the printer can function as the device 13. This enables data transfer from the digital camera as the host 10 to the printer as the device 12.

That is, the USB system including the communication controller 100 allows for direct printing of images in the digital camera from the printer, without a personal computer as the host 10. Further, this USB system allows for data storage in such a manner that a digital camera or a digital video camera is directly connected to a storage device such as hard disk and then transfers data to it.

Note that, a communication controller of the present invention may not have both functions as the host-side controller 11 and the device-side controller 12. That is, a communication controller of the present invention may have a function of the host-side controller 11 of the present invention and a function of a typical and conventional device-side controller (e.g. a device-side controller which generates no SOF packet on its own initiative). Further, a communication controller of the present invention may have a function of the device-side controller 12 of the present invention and a function of a typical and conventional host-side controller (e.g. a host-side controller which does not avoid transmission of a SOF packet to a device side).

A USB system of the present invention (the present system) is a system including the present device-side controller and the present host-side controller. Further, the present device-side controller is preferably set such that the device-side control section transmits the SOF packet to the device at a predetermined interval.

In this case, the present system is preferably set such that the host-side control section of the host-side controller, when having received no packets from the host for longer than a predetermined period, transmits a reset notification signal to the device-side controller, and the device-side control section of the device-side controller, in response to the reset notification signal, stops transmission of the SOF packet to the device.

Further, the device-side control section of the device-side controller is preferably set so as to adjust a transmission timing to transmit a packet other than the SOF packet to the device, so that a SOF packet transmission timing falls outside a period during which the device-side controller communicates with the device in response to the transmission of the packet other than the SOF packet.

In this case, the device-side control section preferably adjusts the transmission timing to transmit, to the device, an OUT packet or a SETUP packet and a DATA packet both of which have been received from the host-side controller, in accordance with a size of the DATA packet.

The present system may be set such that the host-side control section, when having received the SOF packet which has been transmitted from the host to the device, transmits, to the device side, a SOF reception notification signal that indicates completion of reception of the SOF packet; and the device-side control section, in response to the SOF reception notification signal, transmits the SOF packet to the device.

Further, in the present system, the host-side controller and the device-side controller each preferably includes a speed setting section which sets a communication speed between the host-side controller and the device-side controller. Further, the present system may be set such that when the speed setting section sets the communication speed between the host-side controller and the device-side controller to a value equal to or more than a predetermined value, the host-side control section of the host-side controller transmits, to the device, the SOF packet having received from the host, and the device-side control section of the device-side controller transmits, to the device, the SOF packet having received from the host-side controller.

Further, the present system may be set such that at least one of the host-side control section and the device-side control section calculates an error rate in packet transmission and reception between the host-side controller and the device-side controller; and when the error rate is equal to or more than a predetermined value, the speed setting section decreases the communication speed between the host-side controller and the device-side controller.

In the present system, a communication scheme of a communication channel between the host-side controller and the device-side controller is preferably full-duplex communications. Further, a communication channel between the host-side controller and the device-side controller may be provided by an optical cable. Still further, communications between the host-side controller and the device-side controller may be made through optical wireless communications or wireless communications using radio waves.

A packet communications program of the present invention is a program which causes a computer provided avoidance step in the present communications method, and causes a computer provided to a device of a USB system to perform the transmission step in the present communications method. A storage medium of the present invention is a storage medium storing therein this packet communications program.

A second USB system of the present invention is a USB system comprising: a host; a device; a host-side controller, provided to the host, which relays communications between the host and the device; and a device-side controller, provided to the device, which relays communications between the host and the device; wherein: data transfer between the host-side controller and the device-side controller is performed through optical communications; and a data transfer speed in the optical communications is lower than a data transfer speed in high speed mode of USB 2.0.

Further, a present first communication controller may be such that the communication control section, when having received a SOF packet transmitted from the host to the device while the communication controller functions as the host-side controller, avoids transmission of the received SOF packet to a device side.

Still further, the present first communication controller may be set such that while the communication controller functions as the device-side controller, the communication control section transmits a SOF packet to the device at a predetermined interval.

Further, the first communication controller may be such that while the communication controller functions as the device-side controller, the communication control section adjusts a transmission timing to transmit a packet other than the SOF packet to the device, so that a SOF packet transmission timing falls outside a period during which the communication controller communicates with the device in response to the transmission of the packet other than the SOF packet.

Still further, the present first communication controller may be such that while the communication controller functions as the device-side controller, the communication control section adjusts the transmission timing to transmit, to the device, an OUT packet or a SETUP packet and a DATA packet both of which have been received from the host-side controller, in accordance with a size of the DATA packet.

Further, a third USB system of the present invention is a USB system including: a host; a device; and the foregoing first communication controller.

Especially, the present host-side controller preferably includes a host-side control section which, when having received a SOF packet transmitted from the host to the device, avoids transmission of the received SOF packet to a device side. With this arrangement, in the present system, even when the SOF packet is transmitted from the host to the device, this SOF packet is stopped by the present host-side controller, so that the SOF packet is not transmitted from the present host-side controller onward. Therefore, a combined use of the present host-side controller and the present device-side controller easily increases communication efficiency between the present host-side controller and the present device-side controller.

Note that, the present system including the foregoing two controllers is especially effective in such an arrangement that a communication channel of a low communication speed (data transfer speed) (which is lower than a normal speed (e.g. in the HS mode, 480 Mbps) according to the USB standard) is provided between the host and the device. That is, under normal circumstances, the host transmits a SOF packet to the device at evenly spaced time intervals. Because of this, when the communication speed is low, the SOF packet occupies most of the communication channel. This worsens a communication efficiency of other packets.

In such a case, when the host-side controller and the device-side controller are connected to the host and the device, respectively, in such a manner that communications at a normal speed are possible, transmission of the SOF packet between the host-side controller and the device-side controller can be eliminated. Therefore, even in the case of a low communication speed between the host-side controller and the device-side controller, it is possible to suppress a worsening of a communication efficiency involving other packets.

Note that, the present host-side controller may be directly connected to the host or connected to a downstream port of a USB hub. Further, the present host-side controller may be a part of the host or the USB hub. The present device-side controller may be directly connected to the device, or connected to an upstream port of a USB hub. Further, the present device-side controller may be a part of the device or the USB hub.

Further, in the present system, the device-side control section preferably transmits the SOF packet to the device (on its own initiative) at a predetermined interval. This allows the device-side control section to transmit the SOF packet to the device even when it picks up no cue (signal) externally.

Still further, in this case, the host-side control section is preferably set such that when having received no packets for longer than a predetermined period, the host-side control section recognizes that “the host is about to reset the bus of the device” and transmits a reset notification signal to the device-side controller. Then, the device-side control section, in response to the reset notification signal, preferably stops transmission of the SOF packet to the device. This facilitates resetting the bus of the device.

In addition, in the present system, the device-side control section often transmits packets other than the SOF packet in the IN transaction, OUT transaction, SETUP transaction, and other transactions. Further, when having transmitted other packet to the device, the device-side control section sometimes receives a response from the device.

Therefore, it is preferable that in the case where a SOF packet is transmitted to the device at a predetermined interval, the device-side control section adjusts a transmission timing for other packet so that a SOF packet transmission timing falls outside a period during which the device-side controller communicates with the device in response to the transmission of other packet.

In such an adjustment, the device-side control section estimates how much time at the maximum it takes to communicate with the device in response to the transmission of other packet (communication completion time). Then, when the SOF packet transmission timing does not come before the estimated communication completion time elapses, the device-side control section transmits other packet to the device. On the other hand, when the SOF packet transmission timing comes before the communication completion time elapses, the device-side control section transmits other packet after transmission of the SOF packet. Such an adjustment avoids interference with transmission of the SOF packet by transmission and reception of other packets.

Further, in the OUT transaction or SETUP transaction, the device-side control section transmits, to the device, an OUT packet or SETUP packet and a DATA packet both of which have been transmitted from the host side. Then, the device-side control section receives an ACK packet from the device. Therefore, before transmission, the device-side control section can know a size of the DATA packet (packet length) to be transmitted to the device. Therefore, accurate estimation is possible by estimating the above communication completion time in accordance with this size.

Further, the device-side control section may be set so as to transmit the SOF packet to the device when picking up the cue from an external entity (host-side controller). That is, this arrangement is set such that the host-side control section, when having received the SOF packet transmitted from the host to the device, transmits, to the device, a SOF reception notification signal indicating reception of the SOF packet, and the device-side control section transmits the SOF packet to the device in response to the SOF reception notification signal.

In this arrangement, the host-side control section transmits, to the device-side controller, the SOF reception notification signal of which transfer time is much shorter than that of the SOF packet, thereby communicating the SOF packet transmission timing to the device-side control section. Therefore, this arrangement increases communication efficiency of a packet other than the SOF packet, as compared to the arrangement in which the SOF packet is transmitted and received between the controllers.

Further, in the present system, the present host-side controller and the present device-side controller each preferably include a speed setting section which sets a communication speed between the present host-side controller and the present device-side controller. This speed setting section is provided with each of the controllers and performs setting of a communication speed (speed negotiation) at the start of communications between the present host-side controller and the present device-side controller.

This arrangement may be set such that when the speed setting section sets a communication speed between the present host-side controller and the present device-side controller to a value equal to or more than a predetermined value, the host-side control section and the device-side control section perform communications of the SOF packet according to normal USB communications. That is, in this case, it may be set such that the host-side control section transmits, to the device side, the SOF packet having received from the host, and the device-side control section transmits the received SOF packet to the device.

Here, the foregoing predetermined value is a value corresponding to a speed, about the above normal speed (normal speed according to the USB standard), at which the SOF packet transmission does not interfere with communications. That is, in this arrangement, when a communication speed between the present host-side controller and the present device-side controller is equal to or more than the predetermined value, the host-side control section directly transmits, to the device side, the SOF packet having received from the host. Then, the device-side control section transfers the received SOF packet to the device.

Thus, if the communication speed between the controllers can be high to some extent, a proportion of the SOF packet in the communication bandwidth between the controllers can be suppressed to a proportion as low as a normal proportion. Therefore, transmission and reception of the SOF packet does not worsen a communication efficiency of other packet.

In the present system, after the speed setting section sets the communication speed, at least one of the host-side control section and the device-side control section (or speed setting section) preferably calculates an error rate in packet transmission and reception between the host-side control section and the device-side control section. Here, the error rate (a rate of error occurrence) is a value obtained by division of the number of times errors occur by the number of times transmission and reception are performed. In this case, when the error rate is equal to or more than a predetermined value, the speed setting section preferably decreases the communication speed between the host-side control section and the device-side control section. This reduces a rate of errors caused by too high a communication speed.

Further, in the present system, a communication scheme of a communication channel between the host-side controller and the device-side controller is preferably full-duplex communications. This can eliminate a preamble necessary for the half-duplex communications, thus increasing the communication efficiency between the host-side controller and the device-side controller.

Still further, in the present system, a communication channel between the host-side controller and the device-side controller may be provided by an optical cable (optical fiber). This allows for long-distance packet transmissions.

Yet further, communications between the host-side controller and the device-side controller may be made through optical wireless communications or wireless communications using radio waves. The wireless communications (free-space optical communications) are cable-free communications, thus increasing convenience (flexibility in placement of the controllers).

A packet communications program of the present invention is a program which causes a computer provided to a host of a USB system to perform the transmission avoidance step in the present communications method, and causes a computer provided to a device of a USB system to perform the transmission step in the present communications method.

By loading this program into the foregoing computer, the transmission avoidance step and the transmission step in the present communication method can be realized by that computer. Further, storing this program into a computer-readable storage medium facilitates storage and distribution of the program.

Further, a second USB system of the present invention is a USB system including: a host; a device; a host-side controller, provided to the host, which relays communications between the host and the device; and a device-side controller, provided to the device, which relays communications between the host and the device, wherein: data transfer between the host-side controller and the device-side controller is performed through optical communications; and a data transfer speed in the optical communications is lower (e.g. 100 Mbps) than a data transfer speed (480 Mbps) in high speed (HS) mode of USB 2.0.

Here, assume that a data transfer speed in the optical communications between the controllers is 480 Mbps, as with the HS mode. In this case, when a modulation scheme of 8B10B, for example, is used, an optical transmitter and an optical receiver (optical transceiver) each having a bandwidth of 480×10/8=600 Mbps are necessary. To obtain such an optical transmitter, the use of an LD (laser diode) is necessary.

On the other hand, assume that a data transfer speed in the optical communications between the controllers is 100 Mbps. In this case, the optical transmitter can be realized by using LED (light-emitting diode). If comparisons are made between the LD and the LED, the LED is less expensive by far than the LD. Therefore, decrease of a speed in the optical communications between the controllers realizes the controllers arranged at low cost. Such an arrangement significantly decreases a bandwidth required for the controllers from 600 Mbps to 100 Mbps. This allows for manufacture of the controllers in more inexpensive manufacture process.

Note that, when a device of a low data transfer speed (e.g. flash memory; about 50 Mbps) is used as the device, a time required for completion of the transaction highly depends on a transfer speed of the device. Therefore, it can be said that if the data transfer speed between the controllers is faster than a transfer speed of the device, the transfer speed of the device does not have a significant impact on the time required for completion of the transaction. Therefore, it is preferable that a data transfer speed in the optical communications between the controllers is faster than a device transfer speed of the device.

A communication controller of the present invention (the present communication controller) is a communication controller which relays communications between a host and a device and includes functions as a host-side controller and a device-side controller, the communication controller comprising: a communication control section which, while the communication controller functions as the device-side controller, transmits a SOF packet to the device after connection between the host and the device has been established.

The present communication controller is applied to a USB system. Here, the USB system is a communications system for realizing USB communications (data communications according to the USB standard) between a host computer (host) and its peripheral (device; USB function).

The present communication controller relays communications between the host and the device. That is, the present communication controller has a function of receiving a packet transmitted from the device and transmitting it to the host, and a function of receiving a packet transmitted to the device and transmitting it to the device, while functioning as the device-side controller. Here, the packet is a basic unit of data communicated in the USB system.

Further, the USB system is defined so that the SOF packet, one of packets, is transmitted in preference to other packets, from the host to the device. The present communication controller includes a communication control section which generates this SOF packet on its own initiative and transmits it to the device.

With this arrangement, the use of the present communication controller eliminates the need for transmission and reception of the SOF packet between the host and the present communication controller (i.e. the use of the present communication controller eliminates the need for transmission of the SOF packet from the host side to the device.). With this arrangement, a communication channel between the host and the present communication controller can be used only for packets other than the SOF packet. This allows increase in communication efficiency of these other packets.

A USB system of the present invention (the present system) is a USB system including the present communication controllers, in addition to the host and the device. Establishment of such a system enables increase in packet communication efficiency.

The present communication controller can function as the host-side controller. That is, the present communication controller, while functioning as the host-side controller, receives a packet transmitted from the host and transmits it to the device, and receives a packet transmitted to the host and transmits it to the host.

Thus, if the present system includes the host, the present communication controller functioning as the host-side controller, the present communication controller functioning as the device-side controller, and the device, a communication channel of the present system is provided in this order. That is, the communication channel is set such that the two communication controllers relay communications between the host and the device.

Especially, the communication control section of the present communication controller, when having received a SOF packet transmitted from the host to the device while the communication controller functions as the host-side controller, preferably avoids transmission of the received SOF packet to a device side. With this arrangement, in the present system, even when the SOF packet is transmitted from the host to the device, this SOF packet is stopped by the present communication controller, so that the SOF packet is not transmitted from the present communication controller onward. This easily increases communication efficiency between the communication controllers.

That is, the present communication controller can be also said as a communication controller which relays communications between the host and the device and has functions as the host-side controller and the device-side controller, the communication controller comprising: a communication control section which, when having received a SOF packet transmitted from the host to the device while the communication controller functions as the host-side controller, avoids transmission of the received SOF packet to a device side.

Note that, the present system including the foregoing communication controllers is especially effective in such an arrangement that a communication channel of low communication speed (data transfer speed) (which is lower than a normal speed (e.g. in the HS mode, 480 Mbps) according to the USB standard) is provided between the host and the device. That is, under normal circumstances, the host transmits a SOF packet to the device at evenly spaced time intervals. Because of this, when the communication speed is low, the SOF packet occupies most of the communication channel. This worsens a communication efficiency of other packets.

In such a case, when the communication controllers are connected to the host and the device, respectively, in such a manner that communications at a normal speed are possible, transmission of the SOF packet between the communication controllers can be eliminated. Therefore, even in the case of a low communication speed between the communication controllers, it is possible to suppress a worsening of a communication efficiency involving other packets.

Note that, the present communication controller may be directly connected to the host or connected to a downstream port of a USB hub. Further, the present communication controller may be a part of the host or the USB hub. In this case, the present communication controller can function as the host-side controller. Further, present communication controller may be directly connected to the device or connected to an upstream port of a USB hub. Still further, the present communication controller may be a part of the device or the USB hub. In this case, the present communication controller can function as the device-side controller.

Thus, the present communication controller has a function as the host-side controller and a function as the device-side controller. With this arrangement, in the USB system, one communication controller can be used as either the host-side controller or the device-side controller.

Therefore, just by providing one type of the communication controller to each of the host and the device, it is possible to establish the present system. That is, the present system can be established without preparation of two types of controllers, so that it is possible to simplify establishment of the system.

Further, the present communication controller can be used in a system where various information devices connected to a USB system function as either the host or the device, depending on situations where the devices are used. Note that, examples of such a USB system include USB-OTG (USB-On-The-Go) that has been standardized recently.

The USB-OTG is a standard which allows devices (peripherals) conventionally connected to a host (personal computer, etc.) via a USB system to have a function as a host. Therefore, a USB system according to the USB-OTG standard allows for data transfer through connection between the devices, which is impossible in the USB1.x and the USB 2.0.

For example, with a USB system built using the present communication controller, a digital camera and a printer are directly connected to each other, so that the digital camera can function as the host and the printer can function as the device. This enables data transfer from the digital camera as the host to the printer as the device.

That is, the USB system including the present communication controller allows for direct printing of images in the digital camera from the printer, without a personal computer as the host. Further, this USB system allows for data storage in such a manner that a digital camera or a digital video camera is directly connected to a storage device such as hard disk and then transfers data to it.

Further, while the present communication controller functions as the device-side controller, the communication control section may transmit the SOF packet to the device at a predetermined interval. This allows the communication controller to transmit the SOF packet to the device even when it picks up no cue (signal) externally.

Further, while the present communication controller functions as the device-side controller, the communication control section may adjust a transmission timing to transmit a packet other than the SOF packet to the device, so that a SOF packet transmission timing falls outside a period during which the communication controller communicates with the device in response to the transmission of the packet other than the SOF packet.

In such an adjustment, the communication control section estimates how much time at the maximum it takes to communicate with the device in response to the transmission of other packet (communication completion time). Then, when the SOF packet transmission timing does not come before the estimated communication completion time elapses, the device-side control section transmits other packet to the device. On the other hand, when the SOF packet transmission timing comes before the communication completion time elapses, the communication control section transmits other packet after transmission of the SOF packet. Such an adjustment avoids interference with transmission of the SOF packet by transmission and reception of other packets.

Further, while the communication controller functions as the device-side controller, the communication control section may adjust the transmission timing to transmit, to the device, an OUT packet or a SETUP packet and a DATA packet both of which have been received from the host-side controller, in accordance with a size of the DATA packet.

In this case, in the OUT transaction or SETUP transaction, the communication control section transmits, to the device, an OUT packet or SETUP packet and a DATA packet both of which have been transmitted from the host side. Then, the communication control section receives an ACK packet from the device. Therefore, before transmission, the communication control section can know a size of the DATA packet (packet length) to be transmitted to the device. Therefore, accurate estimation is possible by estimating the above communication completion time in accordance with this size.

Also, a USB system of the present invention can be a USB system including: a host; a device; and the present communication controllers.

As described above, the present invention is used for a USB system which is a communication system for realizing USB communications (data communications according to the USB standard) between a host computer (host) and its peripheral (device), and for communication controllers (host-side controller, device-side controller) respectively provided to the host and the device in the USB system.

Further, it can be said that the present invention relates to a transmission method and transmission device of USB signals in the USB standard. In addition, it can be said that in the USB, to maintain a connection state, the host and the device communicate with each other at the bottom layers by time-sharing in accordance with their protocol, the host performs scheduling of the communications. Further, data communications under the USB are performed by a unit called as a transaction. This transaction is made up of packets called as token packet, data packet, and handshake packet. The transaction always begins with the token packet issued by the host at the start of the transaction, and the device corresponding to an address and an endpoint contained in the token packet responses.

The endpoint is a FIFO buffer for storing transfer data therein, and data exchange between the USB host and the USB device is always performed via the endpoint. The USB device can have up to 16 endpoints, and each of the endpoints is assigned a number to identify them. At the time of data transfer, the USB host makes access using the USB address and the endpoint of the USB device. An endpoint assigned number “10” in the endpoints is called as endpoint 0, and one endpoint 0 must exist in the endpoints. This endpoint 0 is used during initialization by the SETUP packet at the time of control transfer. In the USB 2.0, when the HS mode is active, the USB host causes the D+ signal line and the D− signal line to be in low levels (SE0) for 10 ms or longer, as a bus reset signal.

The SOF packet is necessary for synchronization isochronous transfer, and in applications that perform no isochronous transfer, the SOF packet is not necessary except for using it to indicate no reset. Even in applications that perform isochronous transfer, a SOF reception timing is important in view of the USB device. As to a frame number of the SOF packet, it is considered that a frame number of the SOF packet transmitted by the USB host is not necessarily identical with a frame number of the SOF packet received by the USB device as far as communications are performed in accordance with the above rule defined in the USB 2.0.

Further, the present invention may be composed of the host-side controller connected on the USB host side and the device-side controller connected on the USB device side. The host-side controller receives a signal from the USB host, transmits it to the USB device, and transmits a signal from the device-side controller to the USB host. In addition to the arrangement in which the host-side controller is connected to the USB host via a USB cable, the host-side controller may be arranged so as to be connected via the USB cable to a downstream port of a USB hub. Further, the host-side controller may be a part of the USB host or the USB hub. The device-side controller transmits a signal from the host-side controller device to the host-side controller. In addition to the arrangement in which the device-side controller is connected to the USB device via a USB cable, the device-side controller may be arranged so as to be connected via the USB cable to an upstream port of the USB hub. Further, the device-side controller may be a part of the USB host or the USB hub.

In the case where a speed on a communication channel between the host-side controller and the device-side controller is equal to or lower than that on a USB communication channel, a timing for repeating a packet on the communication channel may be adjusted. In the present system, the host SM 32 performs packet exchanges with the USB host and the device-side controller in accordance with predetermined rules in the IN transaction, OUT transaction, and SETUP transaction.

Further, the host SM 32 does not repeat a SOF packet to the device-side controller when the SOF judgment circuit 31 judges that the received packet is a SOF packet as a result of analysis of the USB packet received by the USB receiver 20. Here, examples of a way of refusing a repeat include no writing of SOF packet data into the transmission FIFO 21. However, a repeat may be suppressed by another way.

Further, in the present system, even when there is a communication channel of a speed lower than that of the USB standard between the USB host and the USB device, the host-side controller and the device-side controller each having the foregoing arrangement enable transmission of the SOF packet to the USB device and enable the USB device to be maintained in an active state.

It can be said that in the arrangement in which the host SM 32 transmits the SOF reception notification signal to the device-side controller 12, even when there is a communication channel of a speed lower than that of the USB standard between the USB host and the USB device, transmission of the SOF packet to the USB device is possible without a timer inside the device-side controller, and it is possible to maintain the USB device in an active state.

In the IN transaction, the device SM 42 monitors the timer 29 to determine a SOF packet transmission timing. A maximum length of the DATA packet sent back in response to the IN packet transmitted to the USB device takes any of values illustrated in FIG. 7. On the basis of these values, the device SM 42 can calculate how an IN packet transmission timing should be earlier than a SOF packet transmission timing so that SOF packet transmission timing does not come during reception of the DATA packet, or a value of the timer in which transmission of the IN packet is allowed in view of addition of a period during which the device-side controller sends back an ACK packet to the USB device in response to the DATA packet. This enables such a control of the IN packet transmission timing that if the timer does not reach the value thus obtained, the IN packet is transmitted to the USB device, or if the timer reaches the value thus obtained, the IN packet is transmitted after transmission of the subsequent SOF packet.

Further, it can be said that S42 is a step of judging whether or not the timer 29 reaches a value in a range where the SOF packet transmission timing does not come before the device-side controller transmits the ACK packet in response to the DATA packet of a maximum length transmitted from the USB device in response to the IN packet from the device-side controller. If the timer 29 reaches the above value, the process goes to S44, or if the timer 20 does not reach the above value and it is judged that transmission of the IN packet is allowed, the process goes to S43. It can be said that providing the device SM 42 performing such an operation inside the device-side controller 11 can avoid the occurrence of a state in which transmission of the SOF packet is interfered with by the DATA packet transmitted from the USB device and the IN packet and the ACK packet transmitted from the device-side controller.

In the OUT transaction, the device SM 42 monitors the timer 29 to determine a SOF packet transmission timing. A maximum length of the DATA packet transmitted by the device-side controller takes any of values illustrated in FIG. 7. On the basis of these values, the device SM 42 can calculate how an OUT packet transmission timing and a DATA packet transmission timing should be earlier than a SOF packet transmission timing so that SOF packet transmission timing does not come, or a value of the timer in which start of transmission of the OUT packet is allowed in view of addition of a period during which the USB device transmits an ACK packet in response to the DATA packet. This enables such a control of the IN packet transmission start timing that if the timer does not reach the value thus obtained, the OUT packet and the DATA packet are started being transmitted to the USB device, or if the timer reaches the value thus obtained, the OUT packet and the DATA packet are transmitted after transmission of the subsequent SOF packet. Further, the device-side controller can know a packet length of the DATA packet to be subsequently transmitted. This allows the device SM 42 to constantly calculate a value of the timer for the OUT packet transmission start control so as to control it at the best value. Further, the SETUP packet, the DATA packet, and the ACK packet in the SETUP packet transaction are positioned in the same way as the OUT packet, DATA packet, and the ACK packet in the OUT packet transaction, so that the foregoing arrangement can be applied to the SETUP transaction.

Further, it can be said that S52 is a step of judging whether or not the timer 29 reaches a value in a range where the SOF packet transmission timing does not come before the USB device sends back the ACK packet in response to the OUT packet and the DATA packet. If the timer 29 reaches the above value, the process goes to S54, or if the timer 20 does not reach the above value and it is judged that transmission of the OUT packet is allowed, the process goes to S53.

A problem of the present invention may be expressed as follows. That is, in the case where a communication channel of a transfer speed lower than a USB 2.0's native speed is used between the host and the device, the use of bandwidth for transmission of the SOF packet decreases a bandwidth available for transfer of other packet in a low-speed communication channel. Further, if the SOF packet is not repeated, the device-side controller cannot recognize a bus reset. When a bus is reset, disconnection between the host and the device occurs either temporarily or permanently. Once the host fails recognition of the device, the host might never recognize the device (even if the device is plugged and unplugged). In view of this, it is desirable that the number of times the bus is reset is minimized. What continuously emits light in full-duplex communications is a transmitter such as a light-emitting diode and a laser diode. To perform full-duplex communications, such continuous light emissions are performed. It is preferable to continue light emissions (communications) to repeat a packet received at any time. The presence or absence of a received signal enables control such as connection and disconnection (in the case of half-duplex communications, disconnection occurs when no signals have been received for longer than a given period, so that it is considered that a longer time is needed for disconnection). In free-space optical communications, an error rate significantly varies depending on a transfer speed and a communication distance. In the case of a high transfer speed, a distance over which a normal data transfer is possible is shorter than a distance at a low transfer speed. That is, as to a certain distance, there is the high possibility that signal transmissions are impossible at a high transfer speed. Further, the signal-detect signal is a signal for just judging whether or not there is any received signal, and it can be said that the signal-detect signal is a signal slower than a transfer speed.

Further, it can be said that with the foregoing method described in the Embodiment, even when there is a communication speed lower than a USB's native speed between the USB host and the USB device, it is possible to transmit the SOF packet to the USB device at an interval defined under the USB standard. Also, it is possible to transmit, to the USB device, the bus reset (SE0) for which the USB host emits light, without problems. Further, provision of the speed negotiation circuit enables data communications at a best-suited transfer speed. Still further, full-duplex communications enables increase in use efficiency of the communication channel. Yet further, the use of an optical fiber as a low-speed communication channel enables increase in length of a same or lower speed communication channel, which widens the range of applications.

Further, the use of a wireless using radio waves as a low-speed communication channel enables prevention of deterioration of connectors and frees from cables, which improves the ease of use. Still further, the use of optically-based free-space transmissions as a low-speed communication channel enables prevention of deterioration of connectors and enables high-speed free-space optical transmissions. Further, monitoring a value of the timer enables avoidance of a collision between the SOF packet transmitted by the device-side controller and other packet in the following transactions: the IN transaction, the OUT transaction, and the SETUP transaction.

Further, it can be said that an object of the present invention is to suppress decrease in transfer efficiency of a communication channel caused by transfer of the SOF packet and to transmit, to the USB device, a reset signal transmitted from the USB host without problems, when a communication channel of a transfer speed lower than USB 2.0's native speed (e.g. optical communication channel of 100 Mbps) is used.

The present invention to achieve such an object can be expressed as the following first through thirteenth transmission and reception circuits and first transmission and reception method. That is, a first transmission and reception circuit is a transmission and reception circuit which has an interface capable of transferring at a transfer speed equal to or lower than a transfer speed defined under the USB standard, and is a host-side controller which is connected to a downstream port of a USB host or a USB hub or is realized as a part of the USB connected to an upstream port of the USB host or the USB hub or is realized as a part of the USB host or the USB hub; wherein: both of the host-side controller and the device-side controller have a FIFO and a state machine, the host-side controller further has a SOF judgment circuit and does not repeat a SOF packet on a communication channel of a transfer speed equal to or lower than a transfer speed defined under the USB standard, and the device-side controller further has a timer and transmits a SOF packet to a USB device at predetermined intervals.

With this arrangement, it is possible not to transmit and receive the SOF packet between the host-side controller and the device-side controller, and to suppress decrease in transfer efficiency of a communication channel between the host-side controller and the device-side controller, caused by the SOF packet.

Further, a second transmission and reception circuit is a transmission and reception circuit which has an interface capable of transferring at a transfer speed equal to or lower than a transfer speed defined under the USB standard, and has a FIFO, wherein: a host-side controller has further a SOF judgment circuit and transmits, to a device-side controller, a signal indicating reception of a SOF packet, and the device-side controller, when having received a SOF reception notification signal, transmits a predetermined SOF packet to a USB device. This enables synchronization between the host-side controller and the device-side controller.

A third transmission and reception circuit according to the present invention is the foregoing first transmission and reception circuit, wherein: the host-side controller has a timer and, when having received no packets for a predetermined period, recognizes SE0 and then notifies it to the device-side controller; and the device-side controller, when having recognized the SE0 reception notification, stops transmitting the SOF packet. With this arrangement, it is possible to transmit, to the USB device, a bus reset signal transmitted from the USB host, without problems.

A fourth transmission and reception circuit is the foregoing first or second transmission and reception circuit which has a transmission and reception circuit and a transceiver, allowing a plurality of transfer speeds, and performs speed negotiation with other node. With this arrangement, it is possible to perform packet transmissions at the same transfer speed between the host-side controller and the device-side controller, capable of transferring at a plurality of transfer speeds.

A fifth transmission and reception circuit is the foregoing fourth transmission and reception circuit, wherein: in the speed negotiation, if it is judged that communications at a transfer speed equal to or more than a predetermined transfer speed are possible, repeat of the SOF packet is performed only with modulation and demodulation. With this arrangement, if it is judged that a transfer speed on a communication channel is sufficient to satisfy the foregoing maximum turnaround, it is possible to faithfully transmit, to the USB device, a SOF packet transmitted from the USB host.

A sixth transmission and reception circuit is the foregoing fourth transmission and reception circuit, wherein: as a result of analysis of an error rate in a communication channel of a transfer speed equal to or lower than a transfer speed defined under the USB standard, if it is judged that the obtained error rate is worse than a predetermined error rate, communications are performed at a decreased transfer speed. With this arrangement, even if it is judged that a quality of communication channel is poor, data transfer in a communication channel of good quality is possible by decreasing a transfer speed.

A seventh transmission and reception circuit is the foregoing first transmission and reception circuit, wherein: the device-side controller, if a value of the timer is equal to or more than a predetermined value when the device-side controller receives an IN packet from the host-side controller, transmits the IN packet to the USB device after transmitting next SOF packet. With this arrangement, it is possible to avoid the occurrence of a state where after the device-side controller transmits the IN packet to the USB device, the device-side controller cannot transmit a SOF packet because of a DATA packet transmitted from the USB device.

A eighth transmission and reception circuit is the foregoing first transmission and reception circuit, wherein: the device-side controller, if a value of the timer is equal to or more than a predetermined value when the device-side controller receives an OUT packet and a DATA packet, or a SETUP packet and a DATA packet from the host-side controller, transmits the OUT packet and the DATA packet, or the SETUP packet and the DATA packet to the USB device after transmitting next SOF packet. With this arrangement, it is possible to avoid the occurrence of a state where the device-side controller cannot transmit the SOF packet at a given interval because the device-side controller is transmitting the DATA packet to the USB device.

A ninth transmission and reception circuit is the foregoing eighth transmission and reception circuit, wherein: the value of the timer is variable in accordance with a length of the DATA packet received from the host-side controller. With this arrangement, it is possible to set a best-suited value of the timer with respect to a length-varying DATA packet, and to suppress decrease in communication efficiency between the device-side controller and the USB device.

A tenth transmission and reception circuit is any one of the foregoing first through ninth transmission and reception circuits, wherein: communications are performed through full-duplex communications. With this arrangement, it is possible to eliminate a preamble necessary for half-duplex communications, thus increasing use efficiency of a communication channel. A eleventh transmission and reception circuit is any one of the foregoing first through tenth transmission and reception circuits, wherein: communications are performed through long-distance communications using an optical fiber. With this arrangement, it is possible to increase a distance between the USB host and the USB device, which widens the range of applications.

A twelfth transmission and reception circuit is any one of the foregoing first through ninth transmission and reception circuits, wherein: communications between the host-side controller and the device-side controller are performed through wireless communications. This frees from cables and prevents deterioration of connectors. A thirteenth transmission and reception circuit is any one of the foregoing first through tenth transmission and reception circuits, wherein: communications between the host-side controller and the device-side controller are performed through optically-based free-space transmissions. This frees from cables, prevents deterioration of connectors, and enables high-speed free-space optical transmissions. A first transmission and reception method is a transmission and reception method which realizes any one of the foregoing first through thirteenth transmission and reception circuits.

Further, the present invention can be expressed as a USB 2.0 system which is capable of communications at a communication speed lower than a USB 2.0's native speed and is composed of a host-side controller integral with or independent from a USB 2.0 host or a USB 2.0 hub and a device-side controller integral with or independent from a USB 2.0 device or a USB 2.0 hub, wherein: USB 2.0's high speed transfer is performed between the host-side controller and the device-side controller, having a communication channel capable of communications at a communication speed lower than a USB 2.0's native speed.

With the foregoing mechanism, in the case of a slow-speed application, a transfer speed on a low-speed communication channel does not decrease on the whole. When a modulation scheme of 8B10B, for example, is used to simply perform optical modulation of the USB 2.0, an optical transceiver having a bandwidth of 480×10/8=600 Mbps is necessary. What satisfies this as an inexpensive optical transceiver is LD (laser diode). On the other hand, under the situation where using the present invention, a transfer under the USB 2.0 on a low-speed communication channel is performed, when a transfer speed on the low-speed communication channel is 100 Mbps, for example, what satisfies this as an inexpensive optical transceiver is LED (light-emitting diode). If comparisons are made between the LD and the LED, the LED is less expensive by far than the LD. Therefore, the arrangement of the present invention allows for cost reduction of the optical transceiver.

Also, as to controllers, in the arrangement in which the host-side controller is integral with the USB host with optical ports alone and with no other metal ports, a bandwidth required for the controllers decreases significantly from 600 Mbps to 100 Mbps. This means that it is possible to manufacture the controllers in an inexpensive manufacture process, and the present invention allows for cost reduction. As described above, in the case where an application is limited to a low-speed application, the present invention allows for cost reduction, and the present invention is effective for low-speed applications such as a portable telephone and a digital camera, provided with flash memory.

Specific embodiments or examples implemented in the description of the embodiments only show technical features of the present invention and are not intended to limit the scope of the invention. Variations can be effected within the spirit of the present invention and the scope of the following claims.

1. A device-side controller, provided to a device of a USB system, which relays communications between the device and a host,
the device-side controller comprising:
a device-side control section which, after connection between the host and the device has been established, transmits a SOF packet to the device.

2. A host-side controller, provided to a host of a USB system including the host, a device, and a device-side controller, which relays communications between the host and the device,
the device-side controller, provided to the device of the USB system, relaying communications between the device and the host, the device-side controller comprising: a device-side control section which, after connection between the host and the device has been established, transmits a SOF packet to the device,
the host-side controller comprising:
a host-side control section which, when having received a SOF packet transmitted from the host to the device, avoids transmission of the received SOF packet to a device side.

3. A USB system comprising:
a host; and
a device,
the USB system further comprising:
a device-side controller, provided to the device, which relays communications between the host and the device, the device-side controller comprising: a device-side control section which, after connection between the host and the device has been established, transmits a SOF packet to the device; and
a host-side controller, provided to the host, which relays communications between the host and the device, the host-side controller comprising: a host-side control section which, when having received a SOF packet transmitted from the host to the device, avoids transmission of the received SOF packet to a device side.

4. The USB system according to claim 3, wherein:
the device-side control section transmits the SOF packet to the device at a predetermined interval.

5. The USB system according to claim 4, wherein:
the host-side control section in the host-side controller, when having received no packets from the host for longer than a predetermined period, transmits a reset notification signal to the device-side controller; and
the device-side control section in the device-side controller, in response to the reset notification signal, stops transmission of the SOF packet to the device.

6. The USB system according to claim 4, wherein:
the device-side control section in the device-side controller adjusts a transmission timing to transmit a packet other than the SOF packet to the device, so that a SOF packet transmission timing falls outside a period during which the device-side controller communicates with the device in response to the transmission of the packet other than the SOF packet.

7. The USB system according to claim 6, wherein:
the device-side control section adjusts the transmission timing to transmit, to the device, an OUT packet or a SETUP packet and a DATA packet both of which have been received from the host-side controller, in accordance with a size of the DATA packet.

8. The USB system according to claim 3, wherein:
the host-side control section, when having received the SOF packet which has been transmitted from the host to the device, transmits, to the device side, a SOF reception notification signal that indicates completion of reception of the SOF packet; and
the device-side control section, in response to the SOF reception notification signal, transmits the SOF packet to the device.

9. The USB system according to claim 3, wherein:
the host-side controller and the device-side controller each includes a speed setting section which sets a communication speed between the host-side controller and the device-side controller.

10. The USB system according to claim 9, wherein:
when the speed setting section has set the communication speed between the host-side controller and the device-side controller to a value equal to or more than a predetermined value, the host-side control section in the host-side controller transmits, to the device side, the SOF packet having received from the host; and
the device-side control section in the device-side controller transmits, to the device, the SOF packet having received from the host-side controller.

11. The USB system according to claim 9, wherein:
at least one of the host-side control section and the device-side control section calculates an error rate in packet transmission and reception between the host-side controller and the device-side controller; and
when the error rate is equal to or more than a predetermined value, the speed setting section decreases the communication speed between the host-side controller and the device-side controller.

12. The USB system according to claim 3, wherein:
a communication scheme of a communication channel between the host-side controller and the device-side controller is full-duplex communications.

13. The USB system according to claim 3, wherein:
a communication channel between the host-side controller and the device-side controller is provided by an optical cable.

14. The USB system according to claim 3, wherein:
communications between the host-side controller and the device-side controller are made through optical wireless communications.

15. The USB system according to claim 3, wherein:
communications between the host-side controller and the device-side controller are made through wireless communications using radio waves.

16. A packet communications method of communicating packets between a host and a device in a USB system,
the method comprising:
a transmission avoidance step of, a host-side control section in a host-side controller provided to the host, avoiding transmitting, to a device side, a SOF packet having been transmitted from the host; and
a transmission step of, a device-side control section in a device-side controller provided to the device, transmitting a SOF packet to the device.

17. A packet communications program for causing a computer provided to a host of a USB system to perform a transmission avoidance step of avoiding transmitting, to a device side, a SOF packet having transmitted from the host, and causing a computer provided to a device of the USB system to perform a transmission step of transmitting a SOF packet to the device.

18. A storage medium storing therein a packet communications program for causing a computer provided to a host of a USB system to perform a transmission avoidance step of avoiding transmitting, to a device side, a SOF packet having transmitted from the host, and causing a computer provided to a device of the USB system to perform a transmission step of transmitting a SOF packet to the device.

19. A USB system comprising:
a host;
a device;
a host-side controller, provided to the host, which relays communications between the host and the device; and
a device-side controller, provided to the device, which relays communications between the host and the device,
wherein:
data transfer between the host-side controller and the device-side controller is performed through optical communications; and
a data transfer speed in the optical communications is lower than a data transfer speed in high speed mode of USB2.0.

20. A communication controller which relays communications between a host and a device and includes functions as a host-side controller and a device-side controller,
the communication controller comprising:
a communication control section which, while the communication controller functions as the device-side controller, transmits a SOF packet to the device after connection between the host and the device has been established.

21. A communication controller which relays communications between a host and a device and includes functions as a host-side controller and a device-side controller,
the communication controller comprising:
a communication control section which, when having received a SOF packet transmitted from the host to the device while the communication controller functions as the host-side controller, avoids transmission of the received SOF packet to a device side.

22. The communication controller according to claim 20, wherein:
while the communication controller functions as the host-side controller, the communication control section, when having received a SOF packet transmitted from the host to the device, avoids transmission of the received SOF packet to a device side.

23. The communication controller according to claim 22, wherein:
while the communication controller functions as the device-side controller, the communication control section transmits a SOF packet to the device at a predetermined interval.

24. The communication controller according to claim 23, wherein:
while the communication controller functions as the device-side controller, the communication control section adjusts a transmission timing to transmit a packet other than the SOF packet to the device, so that a SOF packet transmission timing falls outside a period during which the communication controller communicates with the device in response to the transmission of the packet other than the SOF packet.

25. The communication controller according to claim 24, wherein:
while the communication controller functions as the device-side controller, the communication control section adjusts the transmission timing to transmit, to the device, an OUT packet or a SETUP packet and a DATA packet both of which have been received from the host-side controller, in accordance with a size of the DATA packet.

26. A USB system comprising:
a host;
a device;
a communication controller which relays communications between the host and the device and includes functions as a host-side controller and a device-side controller, the communication controller comprising: a communication control section which, while the communication controller functions as the device-side controller, transmits a SOF packet to the device after connection between the host and the device has been established; and
a communication controller which relays communications between the host and the device and includes functions as a host-side controller and a device-side controller, the communication controller comprising: a communication control section which, when having received a SOF packet transmitted from the host to the device while the communication controller functions as the host-side controller, avoids transmission of the received SOF packet to a device side.
